(19) United States
(12) Patent Application Publication
(10) Pub. No.: US 2026/0194116 A1
(43) Pub. Date: Jul. 9, 2026

(54) BRAKE APPARATUS FOR VEHICLE

(71) Applicant: HYUNDAI MOBIS CO., LTD., Seoul (KR)

(72) Inventors: Sang Pil BOO, Yongin-si (KR); Choong Sik SHIN, Yongin-si (KR); Se Hoon AN, Yongin-si (KR); Dae Ung JEON, Yongin-si (KR)

(73) Assignee: HYUNDAI MOBIS CO., LTD., Seoul (KR)

(21) Appl. No.: 19/386,875

(22) Filed: Nov. 12, 2025

(30) Foreign Application Priority Data
Jan. 3, 2025 (KR) 10-2025-0001124
Feb. 4, 2025 (KR) 10-2025-0014104
Jun. 20, 2025 (KR) 10-2025-0081987

(51) Int. Cl. F16D 65/18; F16C 19/16; F16D 55/00; F16D 55/226; F16D 65/00; F16D 121/24; F16D 125/40

(52) U.S. Cl. CPC F16D 65/18; F16C 19/163; F16D 55/226; F16D 65/0068; F16C 2361/45; F16D 2055/0016; F16D 2121/24; F16D 2125/40

(57) ABSTRACT

A brake apparatus for a vehicle includes a caliper body including a cylinder, a piston movably disposed in the cylinder and disposed to face a brake pad, a nut screw disposed within the piston and rotated by a rotational force from an actuator, a bolt screw including a bolt body combined with the nut screw and receiving a rotational force from the nut screw and a bolt head provided separately from the bolt body, combined with the bolt body, and disposed to face the piston, a bearing including an outer ring coming into contact with an inner surface of the cylinder and a bearing ball disposed between the outer ring and the nut screw, and a stopper combined with the outer ring and restricting a relative movement of the nut screw for the outer ring.

### CROSS-REFERENCE TO RELATED APPLICATIONS

This application claims priority from and the benefit of Korean Patent Application Nos. 10-2025-0001124, 10-2025-0014104, and 10-2025-0081987, filed on Jan. 3, Feb. 4, and Jun. 20, 2025, respectively, which are hereby incorporated by reference for all purposes as if set forth herein.

### BACKGROUND

### Field

Exemplary embodiments of the present disclosure relate to a brake apparatus for a vehicle, and more particularly, to a brake apparatus for a vehicle, which can secure stable braking performance.

### Description of the Related Art

In general, the brake apparatus for a vehicle closely attaches a pad and a disk by pushing a piston by its driving force and brakes the vehicle by using a frictional force between the pad and the disk.

An electro mechanical brake (EMB), among brake apparatuses for a vehicle, has a motor driving actuator mounted on a caliper without using hydraulic pressure, and generates a braking force by pressurizing a piston through a mechanism in which the rotational motion of a screw is converted into the linear motion of a nut or the rotational motion of the nut is converted into the linear motion of the screw.

The EMB can implement each of additional functions, such as an anti-lock brake system (ABS), electric stability control (ESC), a traction control system (TCS), and automatic emergency braking (AEB), in addition to common main braking because the EMB enables active braking and wheel-based independent braking, and can implement higher performance because there is no delay in the transmission of hydraulic pressure.

A conventional EMB has problems in that an outside diameter within the caliper is increased and an assembly process becomes complicated as the diameter of a ball is increased if a four-point contact ball bearing is used in order to support the rotational motion of the nut. Furthermore, there are problems in that noise is generated upon operation and braking performance is reduced because the four-point contact ball bearing is moved on the nut if the four-point contact ball bearing is assembled with the nut.

The background technology of the present disclosure is disclosed in Korean Patent Application Publication No. 10-2024-0054695 (Apr. 26, 2024) entitled “BRAKE APPARATUS FOR VEHICLE”).

### SUMMARY

Various embodiments are directed to providing a brake apparatus for a vehicle, which can support the rotational motion of a nut screw by a two-point contact ball bearing.

Various embodiments are directed to providing a brake apparatus for a vehicle in which the bolt body and bolt head of a bolt screw are fabricated as separate products.

Various embodiments are directed to providing a brake apparatus for a vehicle in which the contact diameter of the bolt head that comes into contact with a piston can be enlarged.

Various embodiments are directed to providing a brake apparatus for a vehicle, which improves braking performance because a nut screw returns to its regular position upon braking release.

Various embodiments are directed to providing a brake apparatus for a vehicle in which a bearing can be firmly fixed on the nut screw.

Various embodiments are directed to providing a brake apparatus for a vehicle, which can improve braking performance because the displacement of an outer ring of the bearing can be restricted within a set range in a braking process and a braking release process.

A brake apparatus for a vehicle according to a first aspect of the present disclosure includes a caliper body including a cylinder, a piston movably disposed in the cylinder and disposed to face a brake pad, a nut screw disposed within the piston and rotated by receiving a rotational force from an actuator, a bolt screw including a bolt body combined with the nut screw and configured to receive a rotational force from the nut screw and a bolt head provided separately from the bolt body, combined with the bolt body, and disposed to face the piston, a bearing including an outer ring configured to come into contact with an inner surface of the cylinder and a bearing ball disposed between the outer ring and the nut screw, and a stopper part combined with the outer ring and configured to restrict a relative movement of the nut screw for the outer ring.

The stopper may have one side combined with the outer ring and the other side extended toward the nut screw and may restrict a movement of the nut screw toward the piston within a set range.

The stopper may have one end combined with an inner surface of the outer ring and the other end disposed in front of a nut shoulder portion of the nut screw. When the nut screw is moved toward the piston, the movement of the nut screw may be blocked when the nut shoulder portion comes into contact with the stopper.

The stopper may have one end combined with an outer surface of the outer ring and the other end disposed in front of a nut shoulder portion of the nut screw. When the nut screw is moved toward the piston, the movement of the nut screw may be blocked when the nut shoulder portion comes into contact with the stopper.

The stopper may have one side combined with the nut screw and the other side extended toward the outside and may restrict a movement of the nut screw toward the piston within a set range.

The stopper may have one end combined with a nut bottom portion of the nut screw that faces the outer ring and the other end disposed in the rear of the outer ring. When the nut screw is moved toward the piston, the movement of the nut screw may be blocked when the stopper comes into contact with the outer ring.

The stopper may have one end combined with a nut bottom portion of the nut screw and a stepped portion and the other end disposed in the rear of the outer ring. When the nut screw is moved toward the piston, the movement of the nut screw may be blocked when the stopper comes into contact with the outer ring.

The bolt head may include a head connection part combined with the bolt body and configured to have the outside diameter greater than the outside diameter of the bolt body and a head extension part extended from the head connection part toward the piston and configured to have the outside diameter greater than the outside diameter of the head connection part.

The head extension part may include a curved part in an outer circumference of the head extension part toward the piston. The head extension part may come into contact with the piston on the curved part.

When the piston is tilted with respect to a central axis, the head extension part may perform a rolling motion on the piston in the curved part, and the nut screw may perform a rolling motion on the bearing.

A brake apparatus for a vehicle according to a second aspect of the present disclosure may include a caliper body including a cylinder, a piston movably disposed in the cylinder and disposed to face a brake pad, a nut screw disposed within the piston, rotated by receiving a rotational force from an actuator, and including the outside ball rail that forms a circulation path of a ball member in an inner circumferential surface thereof, a bolt screw including a bolt body combined with the nut screw and configured to receive a rotational force from the nut screw and a bolt head provided separately from the bolt body, combined with the bolt body, and disposed to face the piston, wherein an inside ball rail disposed to face the outside ball rail and configured to form the circulation path of the ball member is provided in an outer circumferential surface of the bolt body, a bearing disposed between the cylinder and the nut screw and configured to support the nut screw so that the nut screw is rotatable within the cylinder, and a location fixing part configured to come into contact with and support the bearing so that a location of the bearing is fixed on the nut screw. The nut screw may include a first return hole part through which the ball member is able to enter and exit, a return passage configured to communicate with the first return hole part, and a second return hole part that communicates with the return passage and through which the ball member is able to enter and exit.

The ball member that enters the first return hole part may be guided into the second return hole part through the return passage. The ball member that enters the second return hole part may be guided into the first return hole part through the return passage.

The first return hole part may be disposed to be closer to the piston than to the second return hole part.

The bearing may include an outer ring configured to come into contact with an inner surface of the cylinder, an inner ring configured to be rotatable within the outer ring and to come into contact with the nut screw, and a bearing ball disposed between the outer ring and the inner ring.

The location fixing part may include a contact ring part configured to come into contact with the inner ring when the location fixing part is combined with the nut screw.

The contact ring part may be disposed to be spaced apart from the outer ring at a predetermined distance in a direction opposite to the piston.

The location fixing part may further include an extension ring part that is connected to the contact ring part, extended in the direction opposite to the piston, and comes into surface contact with the nut screw.

The location fixing part may include a metal material.

The bolt head may include a head connection part combined with the bolt body and having an outside diameter greater than the outside diameter of the bolt body, and a head extension part extended from the head connection part toward the piston and having an outside diameter greater than the outside diameter of the head connection part.

The head extension part includes a curved part in the outer circumference thereof toward the piston. The head extension part may come into contact with the piston on the curved part.

A brake apparatus for a vehicle according to a third aspect of the present disclosure may include a caliper body including a cylinder, a piston movably disposed in the cylinder and disposed to face a brake pad, a nut screw disposed within the piston and rotated by receiving a rotational force from an actuator, a bolt screw including a bolt body combined with the nut screw and configured to receive a rotational force from the nut screw and a bolt head disposed to face the piston, a bearing disposed between the cylinder and the nut screw and configured to support the nut screw so that the nut screw is rotatable within the cylinder, and a displacement restriction part mounted on an outer surface of the nut screw and configured to restrict a relative movement of the nut screw for the bearing.

The displacement restriction part may have one side mounted on the outer surface of the nut screw and the other side and extended to the outside toward an inner surface of the cylinder and may restrict a movement of the nut screw toward the piston within a set range.

The displacement restriction part may be formed in a ring shape. An inner circumferential part of the displacement restriction part may come into contact with a stepped part of the nut screw. An outer circumferential part of the displacement restriction part may be disposed in the rear of the outer ring. The movement of the nut screw toward the piston may be blocked when the displacement restriction part comes into contact with the outer ring.

The braking apparatus may further include a fixing part configured to come into contact with and support the nut screw so that a location of the displacement restriction part is fixed on the nut screw.

The fixing part may be inserted and mounted on a fixing groove part formed along a circumference of the outer surface of the nut screw.

The fixing part may be formed in a C ring shape, and may include an elastically deformable material.

The fixing part may be formed in a C ring shape, and may include a fixing body having both ends disposed to be spaced apart from each other and reinforcement protrusions configured to protrude from both ends of the fixing body to the outside.

Upon braking operation of the brake apparatus for a vehicle, the displacement restriction part and the bearing may be spaced apart from each other.

The bolt head may include a head connection part connected to the bolt body and having an outside diameter greater than the outside diameter of the bolt body, and a head extension part extended from the head connection part to the piston and having an outside diameter greater than the outside diameter of the head connection part.

The head extension part may include a curved part in an outer circumference thereof toward the piston. The head extension part may come into contact with the piston on the curved part.

According to an embodiment of the present disclosure, the diameter of a ball can be reduced compared to a case in which a four-point contact ball bearing is used because the rotational motion of the nut screw is supported by the two-point contact ball bearing. Accordingly, the outside diameter of the assembly of the bolt screw and the nut screw can be reduced and production costs can be reduced because an assembly process is simplified.

According to an embodiment of the present disclosure, the shape flexibility of the bolt head can be improved because the bolt head is fabricated separately from the bolt body.

According to an embodiment of the present disclosure, a load can be stably transferred to the piston because the contact diameter of the bolt head that comes into contact with the piston is extended.

According to an embodiment of the present disclosure, it is possible to implement zero drag and to secure stable braking performance because the nut screw can return to its regular position upon braking release.

According to an embodiment of the present disclosure, an assembly is simplified and the size of a ball can be reduced because the bearing includes the two-point bearing. Accordingly, the size of the outside diameter of the bolt screw and nut screw assembly can be reduced.

According to an embodiment of the present disclosure, the bearing can be firmly fixed on the nut screw because the location fixing part comes into contact with and supports the inner ring of the bearing.

According to an embodiment of the present disclosure, braking performance can be improved because the location fixing part restricts the displacement of the outer ring of the bearing within a set range in a braking process and a braking release process.

### BRIEF DESCRIPTION OF THE DRAWINGS

FIG. 1 is a perspective view illustrating a brake apparatus for a vehicle according to a first embodiment of the present disclosure.

FIG. 2 is a cross-sectional view schematically illustrating the brake apparatus for a vehicle according to the first embodiment of the present disclosure.

FIG. 3 is a cross-sectional view illustrating a first embodiment of a stopper of the brake apparatus for a vehicle according to the first embodiment of the present disclosure.

FIG. 4 is a cross-sectional view illustrating a second embodiment of the stopper of the brake apparatus for a vehicle according to the first embodiment of the present disclosure.

FIG. 5 is a cross-sectional view illustrating a third embodiment of the stopper of the brake apparatus for a vehicle according to the first embodiment of the present disclosure.

FIG. 6 is a cross-sectional view illustrating a fourth embodiment of the stopper of the brake apparatus for a vehicle according to the first embodiment of the present disclosure.

FIG. 7 is a partially enlarged view of FIG. 2.

FIG. 8 is a partially enlarged view of FIG. 7.

FIG. 9 is a perspective view illustrating an actuator of the brake apparatus for a vehicle according to the first embodiment of the present disclosure.

FIG. 10 is a cross-sectional view schematically illustrating a brake apparatus for a vehicle according to a second embodiment of the present disclosure.

FIG. 11 is a diagram schematically illustrating the return path of a ball member in the brake apparatus for a vehicle according to the second embodiment of the present disclosure.

FIG. 12 is a partially enlarged view of FIG. 10.

FIG. 13 is a partially enlarged view of FIG. 12.

FIG. 14 is a diagram illustrating the state in which a location fixing part is mounted on a nut screw in the brake apparatus for a vehicle according to the second embodiment of the present disclosure.

FIG. 15 is a cross-sectional view schematically illustrating a brake apparatus for a vehicle according to a third embodiment of the present disclosure.

FIG. 16 is an enlarged view of a portion A in FIG. 15.

FIG. 17 is a diagram illustrating a braking operation of the brake apparatus for a vehicle according to the third embodiment of the present disclosure.

FIG. 18 is a diagram illustrating a braking release operation of the brake apparatus for a vehicle according to the third embodiment of the present disclosure.

FIG. 19 is a partially enlarged view of FIG. 15.

FIG. 20 is a partially enlarged view of FIG. 19.

FIG. 21 is an exploded view illustrating a nut screw, the displacement restriction part, and the fixing part according to the third embodiment of the present disclosure.

FIG. 22 is a perspective view illustrating the displacement restriction part and the fixing part according to the third embodiment of the present disclosure.

FIG. 23 is a diagram illustrating that the nut screw, the displacement restriction part, and the fixing part have been combined according to the third embodiment of the present disclosure.

### DETAILED DESCRIPTION

Hereinafter, brake apparatuses for a vehicle according to embodiments of the present disclosure are described with reference to the accompanying drawings. In this process, the thicknesses of lines or the sizes of components illustrated in the drawings may have been exaggerated for the clarity of a description and for convenience′ sake. Terms to be described below have been defined by taking into consideration their functions in the present disclosure, and may be changed depending on a user or operator's intention or practice. Accordingly, such terms should be defined based on the overall contents of this specification.

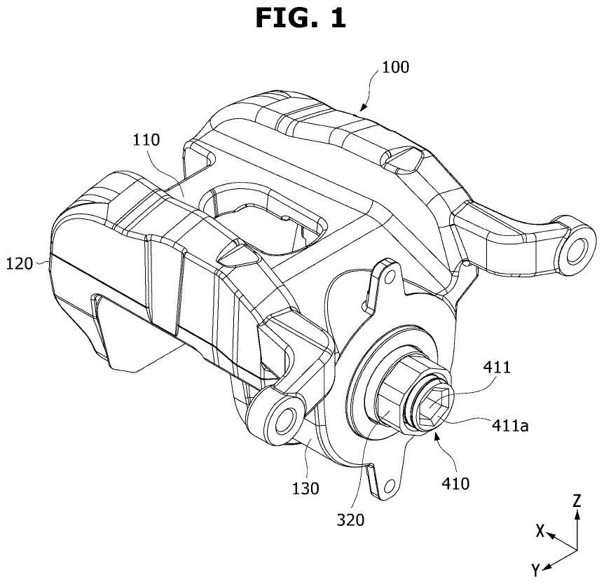

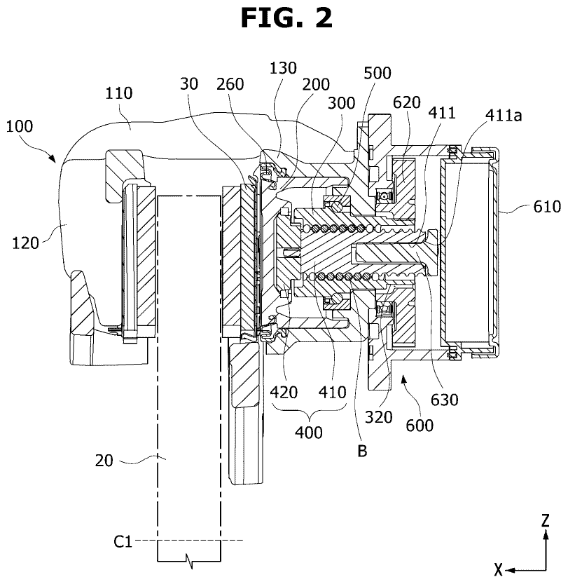

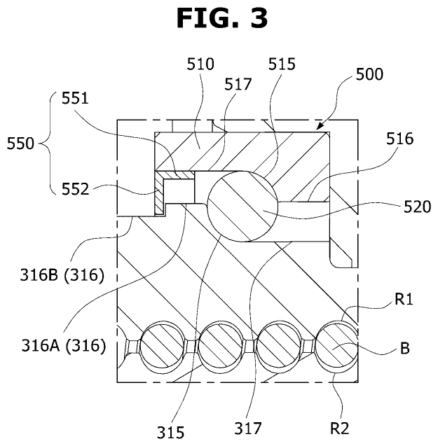

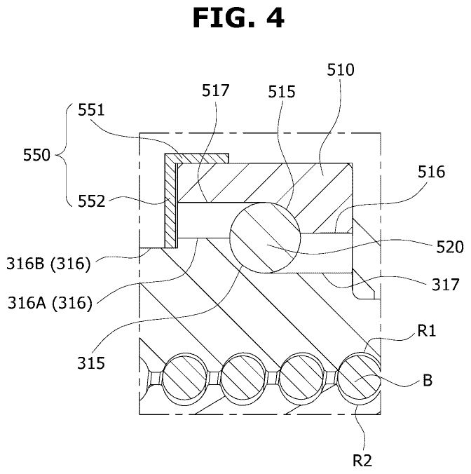

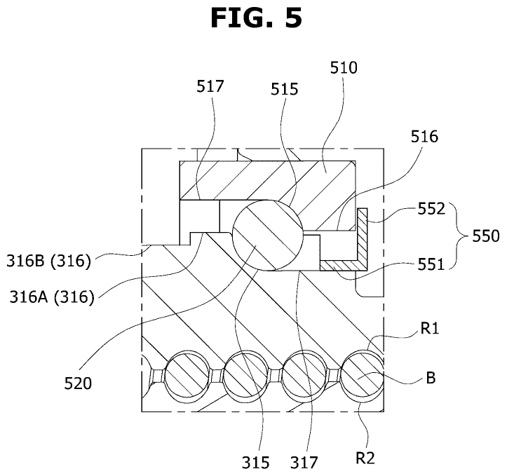

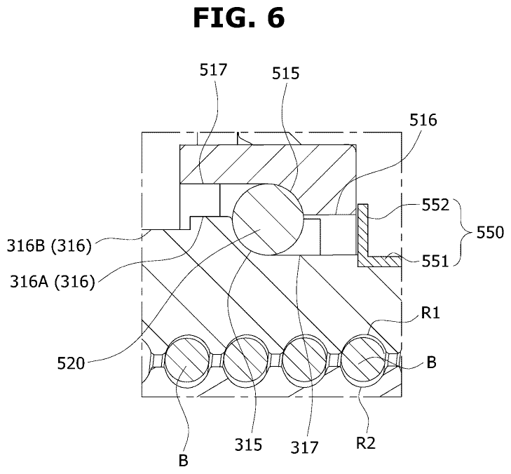

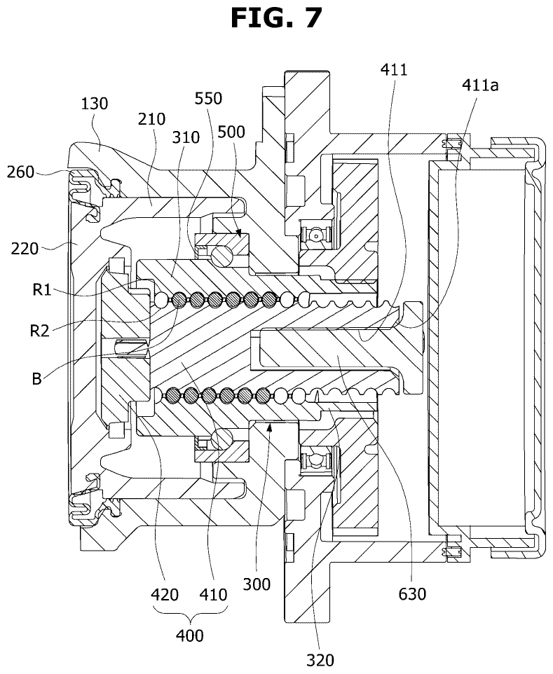

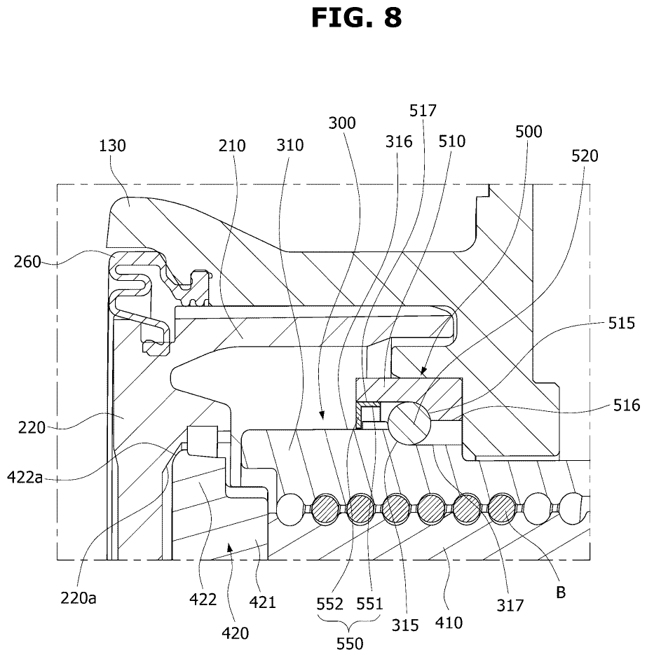

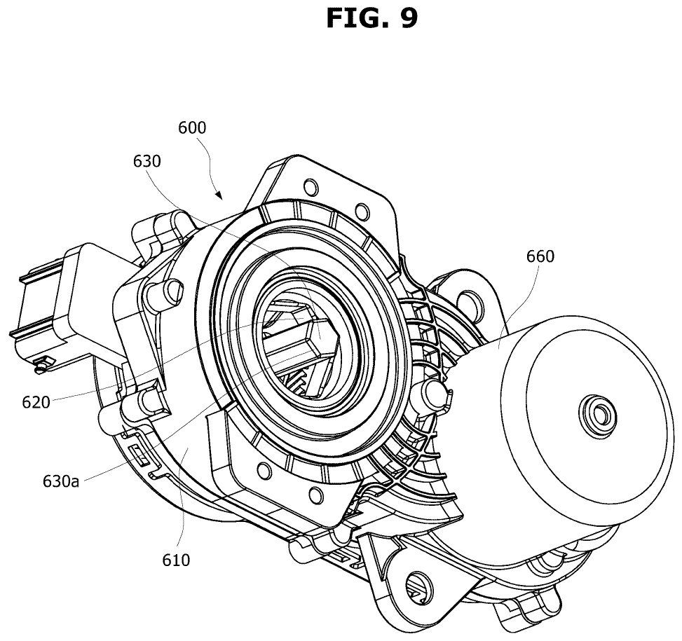

FIG. 1 is a perspective view illustrating a brake apparatus for a vehicle according to a first embodiment of the present disclosure. FIG. 2 is a cross-sectional view schematically illustrating the brake apparatus for a vehicle according to the first embodiment of the present disclosure. FIG. 3 is a cross-sectional view illustrating a first embodiment of a stopper of the brake apparatus for a vehicle according to the first embodiment of the present disclosure. FIG. 4 is a cross-sectional view illustrating a second embodiment of the stopper of the brake apparatus for a vehicle according to the first embodiment of the present disclosure. FIG. 5 is a cross-sectional view illustrating a third embodiment of the stopper of the brake apparatus for a vehicle according to the first embodiment of the present disclosure. FIG. 6 is a cross-sectional view illustrating a fourth embodiment of the stopper of the brake apparatus for a vehicle according to the first embodiment of the present disclosure. FIG. 7 is a partially enlarged view of FIG. 2. FIG. 8 is a partially enlarged view of FIG. 7. FIG. 9 is a perspective view illustrating an actuator of the brake apparatus for a vehicle according to the first embodiment of the present disclosure.

Referring to FIGS. 1 to 9, the brake apparatus for a vehicle according to the first embodiment of the present disclosure may include a caliper body 100, a piston 200, a nut screw 300, and a bolt screw 400.

The caliper body 100 forms an outward appearance of the brake apparatus for a vehicle, and may surround or support the piston 200, the nut screw 300, and the bolt screw 400.

The caliper body 100 may include a bridge 110, a finger 120, and a cylinder 130.

The bridge 110 forms an outward appearance of a central portion of the caliper body 100, and may support the finger 120 and the cylinder 130. The bridge 110 may be connected to a carrier (not illustrated) that is fixed to a knuckle (not illustrated) through the medium of a guide rod (not illustrated).

The bottom of the bridge 110 may be disposed to face the circumferential surface of a brake disk 20 in a way to be spaced apart from the circumferential surface of the brake disk at a predetermined gap. Both ends of the bridge 110 may extend in a first direction (i.e., i.e., a +X direction on the basis of FIG. 2) and a second direction (i.e., i.e., a −X direction on the basis of FIG. 2), that is, a direction opposite to the first direction, respectively, on the basis of the brake disk 20.

A pair of brake pads 30 may be disposed under the bridge 110. The pair of brake pads 30 may be disposed to face each other with the brake disk 20 interposed therebetween.

A friction pad including a material having a high friction coefficient, such as rubber, may be attached to one surface of the brake pad 30 that faces the brake disk 20.

The finger 120 may extend downward from one side of the bridge 110. The finger 120 may be disposed to face any one of the pair of brake pads 30.

The cylinder 130 may extend downward from the other side of the bridge 110. The cylinder 130 is formed in a hollow column shape. One side (i.e., the left side on the basis of FIG. 2) of the cylinder 130 may be disposed to face the other of the pair of brake pads 30.

One side of the cylinder 130 may be opened. The opened one side of the cylinder 130 may be spaced apart from the brake pad 30, at a predetermined gap, which is spaced apart from the brake disk 20 in the second direction.

The central axis of the cylinder 130 may be disposed in parallel to a central axis C1 of the brake disk 20. The central axis of the cylinder 130 may be spaced apart from the central axis C1 of the brake disk 20 in a third direction (i.e., a +Z direction on the basis of FIG. 2).

The third direction may be exemplified as a direction that is perpendicular to the first direction and the second direction and that is directed from the central axis C1 of the brake disk 20 toward the central axis of the cylinder 130.

The third direction may be a direction that is perpendicular to the ground, that is, a direction that rises in the Z axis direction on the basis of FIG. 2, when the bottom of the bridge 110 is disposed in parallel to the ground.

The piston 200 may be movably disposed in the cylinder 130 in the first direction (i.e., the +X direction on the basis of FIG. 2) or the second direction (i.e., the −X direction on the basis of FIG. 2). The piston 200 is disposed within the cylinder 130.

The piston 200 is formed in a hollow column shape. A side of the piston 200 toward the brake pad 30 may be closed. The piston 200 may be disposed in the length direction of the cylinder 130.

An outer surface of the piston 200 may be slidably supported by the inner surface of the cylinder 130. In contrast, the outer surface of the piston 200 may be spaced apart from the inner surface of the cylinder 130 at a set distance.

As the piston 200 is moved in the first direction, the piston 200 may protrude to the outside of the cylinder 130, and may press the brake pad 30 disposed to face the cylinder 130 toward the brake disk 20. Accordingly, the brake apparatus for a vehicle may generate a braking force.

When the piston 200 is moved in the second direction, the piston 200 may be spaced apart from the brake pad 30. Accordingly, the pressing force of the piston 200 that is applied to the brake pad 30 is released, and the braking force of the brake apparatus for a vehicle disappears.

The piston 200 may include a piston body 210 and a piston head 220.

The piston body 210 is formed in a hollow column shape. The piston head 220 is connected to the piston body 210 so that the piston body closes one side (i.e., the left side on the basis of FIG. 2) of the piston body 210. The piston head 220 is disposed on a side that faces the brake pad 30, among both sides of the piston body 210 that have been opened, and closes an opened area of the piston body 210.

The bolt screw 400 may be disposed within the piston 200. The bolt body 410 and bolt head 420 of the bolt screw 400 are surrounded by the piston body 210. The bolt head 420 may be disposed to be inserted into the piston head 220.

A piston boot 260 that prevents the introduction of an external alien substance and that water-tightly seals the inside of the cylinder 130 may be installed within the cylinder 130. The piston boot 260 may be installed between the cylinder 130 and the piston 200. The piston boot 260 is combined with the piston body 210 or the piston head 220, and may be press-fitted within the cylinder 130.

The piston boot 260 may be formed to surround the piston 200. The piston boot 260 may include an elastically deformable material. For example, the piston boot 260 may be fabricated by using a rubber material. The piston boot 260 may be formed to have a ruffled shape.

The nut screw 300 is rotatably disposed in the cylinder 130, and may be combined with the bolt screw 400. A bearing 500 that rotatably supports the nut screw 300 may be installed within the cylinder 130. The bearing 500 may be a ball bearing that is disposed between the cylinder 130 and the nut screw 300.

The nut screw 300 may have a column shape in which the nut screw 300 has an empty inside and both ends opened. The nut screw 300 is disposed within the cylinder 130, and may have a central axis placed on the same axis line as the central axis of the cylinder.

One side (i.e., the left side on the basis of FIG. 2) of the nut screw 300 may be disposed to face the inner surface (i.e., a right surface on the basis of FIG. 2) of the piston 200 in a way to be spaced apart from the inner surface of the piston at a predetermined gap. The other side (i.e., the right side on the basis of FIG. 2) of the nut screw 300 may protrude to the outside of the cylinder 130 through the cylinder 130.

The inner surface of the nut screw 300 may be disposed to face the outer surface of the bolt screw 400. An outside ball rail R1 on which a ball member B having a spherical shape is seated may be formed in the inner circumferential surface of the nut screw 300. The outside ball rail R1 extends in the length direction of the nut screw 300 in a spiral form. The outside ball rail R1 of the nut screw 300 forms the circulation path of the ball member B along with an inside ball rail R2 of the bolt screw 400 on a side opposite to the side of the outside ball rail R1.

The nut screw 300 receives a rotational force generated by an actuator 600 through a power transfer part when the actuator 600 operates, and may be rotated in a clockwise direction or counterclockwise direction around a central axis thereof.

The nut screw 300 may include a nut screw body 310 and a nut screw tail 320.

Most of the nut screw body 310 is disposed within the cylinder 130. Most of or the entire nut screw tail 320 may be exposed to the outside of the cylinder 130. The nut screw body 310 may be surrounded by the piston body 210.

The nut screw tail 320 may be formed in a non-circular column shape. The non-circular shape refers to a shape not a normal circle, and includes shapes, such as an ellipse and a polygon. In the present embodiment, the nut screw tail 320 is formed to have a polygonal column, specifically, an approximately hexagonal column shape.

The bolt screw 400 may be moved in the first direction and the second direction within the cylinder 130 while operating in conjunction with the rotation of the nut screw 300. The bolt screw 400 may be disposed within the nut screw 300. The bolt screw 400 may be disposed to penetrate both ends of the nut screw 300.

The bolt screw 400 is moved in the first direction, that is, a direction toward the brake pad 30, and may move the piston 200 so that the piston 200 pressurizes the brake pad 30. Furthermore, the bolt screw 400 may release pressurization for the piston 200 as the bolt screw 400 is moved in the second direction, that is, the direction opposite to the first direction.

The bolt screw 400 may include the bolt body 410 and the bolt head 420.

The bolt body 410 is combined with the nut screw 300, and may receive a rotational force from the nut screw 300. The bolt head 420 may be provided separately from the bolt body 410. The bolt body 410 may be integrated with the bolt head 420 by being press-fitted and combined with the bolt head 420. For example, the bolt body 410 may be serrated and press-fitted in the bolt head 420.

As the bolt head 420 is fabricated separately from the bolt body 410, the shape flexibility of the bolt head 420 can be improved. In particular, a shape of the bolt head 420 may be changed depending on the specifications of the brake apparatus for a vehicle. As the bolt head 420 is formed separately from the bolt body 410 which may be relatively easy standardized, customizing is easy and a degree of freedom of design can be increased. According to the present embodiment, when the size of the piston 200 is changed, the contact diameter of the bolt head 420 can be easily changed in accordance with the change.

When the bolt body 410 is translationally moved within the cylinder 130 in the first direction while operating in conjunction with the rotation of the nut screw 300, the bolt head 420 disposed in front (the left side on the basis of FIG. 2) of the bolt body 410 pressurizes the piston 200.

The bolt body 410 may be formed in a column shape in which the bolt body 410 has an approximately circular cross section. The bolt body 410 is disposed within the cylinder 130, and may have a central axis placed on the same axis line as the central axis of the cylinder 130. The bolt body 410 may be combined with the nut screw 300 through the medium of the ball member B.

The inside ball rail R2 on which the ball member B is seated may be formed in the outer circumferential surface of the bolt body 410. The inside ball rail R2 may provide the circulation path of the ball member B by extending in a spiral form in the length direction (i.e., the left and right direction on the basis of FIG. 2) of the bolt body 410. Accordingly, when the nut screw 300 is rotated, the bolt body 410 may be moved in the first direction or the second direction by the circulation movement of the ball member B.

The outside ball rail R1 formed in the inner circumferential surface of the nut screw 300 and the inside ball rail R2 formed in the outer circumferential surface of the bolt body 410 may be disposed to face each other. The ball member B may have an external portion guided by the outside ball rail R1 and an inside portion guided by the inside ball rail R2, and may be moved in a spiral form along the outside ball rail R1 and the inside ball rail R2.

The bolt head 420 may be disposed between the bolt body 410 and the piston 200. The bolt head 420 may be formed to have an approximately circular cross section. The bolt head 420 may be disposed to be inserted into the piston head 220. The bolt head 420 may be disposed to face the inner surface of the piston head 220 by being spaced apart from the inner surface of the piston head 220 at a predetermined gap. When a braking force is not generated or a braking force is released in the brake apparatus for a vehicle, the bolt head 420 may be disposed to be spaced apart from the piston head 220.

The bolt head 420 may pressurize the piston head 220. The bolt head 420 may pressurize the piston head 220 in the first direction in the moving direction of the bolt body 410 or may release pressurization for the piston head 220.

The outside diameter of the bolt head 420 may be greater than the outside diameter of the bolt body 410. Accordingly, when the bolt screw 400 moves the piston 200 toward the brake pad 30 by pressurizing the piston 200, the contact diameter of the bolt screw 400 that comes into contact with the piston 200 may be extended.

When the outside diameter of the bolt head 420 that comes into contact with the piston head 220 is greater than the outside diameter of the bolt body 410 compared to a case in which the outside diameter of the bolt head 420 is equal to or smaller than the outside diameter of the bolt body 410, efficiency of a load transfer to the piston 200 through the bolt head 420 can be improved because the contact diameter of the bolt head 420 that comes into contact with the piston head 220 is further extended. Furthermore, as the contact diameter of the bolt head 420 that comes into contact with the piston head 220 is extended, a load can be stably transferred to the piston 200, and the centering of the bolt screw 400 can be stably maintained.

The bolt head 420 may include a head connection part 421 and a head extension part 422.

The head connection part 421 is a part toward the bolt body 410 in the bolt head 420 and combined with the bolt body 410. The head extension part 422 is extended from the head connection part 421 toward the piston head 210, and may have an outside diameter greater than the outside diameter of the head connection part 421. Accordingly, the contact diameter of the bolt screw 400 that comes into contact with the piston 200 can be extended.

When the outside diameter of the head extension part 422 that comes into contact with the piston head 220 is greater than the outside diameter of the head connection part 421 compared to a case in which the outside diameter of the head extension part 422 is the same as the outside diameter of the head connection part 421, efficiency of a load transfer to the piston 200 through the bolt head 420 can be further improved because the contact diameter of the head extension part 422 that comes into contact with the piston head 220 is further extended. Furthermore, as the contact diameter of the head extension part 422 that comes into contact with the piston head 220 is extended, the transfer of a load to the piston 200 is performed more stably.

The head extension part 422 may include a curved part 422a on the outer circumference of the head extension part 422 toward the piston head 220.

The head extension part 422 may include the curved part 422a on the outer circumference of the head extension part 422 toward the piston head 220. The curved part 422a includes a curved surface having a shape in which the curved surface is convexed toward the piston head 220, and may be formed in the entire outer circumference of the head extension part 422. The head extension part 422 may come into contact with the piston head 220 on the curved part 422a.

The head extension part 422 may roll and come into contact with the piston head 220 on the curved part 422a. That is, the head extension part 422 may perform a rolling motion on the piston head 220 on the curved part 422a.

The piston head 220 may include a plane part 220a at a portion thereof that comes into contact with the curved part 422a. Accordingly, when the head extension part 422 is brought into contact with the piston head 220 by a movement of the bolt screw 400 in the first direction, although the head extension part 422 performs a rolling motion on the piston head 220, the head extension part 422 including the convex curved part 422a and the piston head 220 including the plane part 220a can maintain a contact state.

When a braking force is generated because the brake disk 20 has a friction with the brake pad 30 by a movement of the piston 200, a shape of the caliper body 100 may be partially deformed by a reaction of the braking force. Accordingly, the cylinder 130 and the piston 200 may be slightly tilted with respect to the central axis compared to a non-braking state. That is, the cylinder 130, or the piston 200, or both in the braking state may be tilted at a fine angle to the central axis.

When the cylinder 130, or the piston 200, or both are tilted with respect to their central axes, the head extension part 422 may roll and come into contact with the piston head 220 on the curved part 422a. That is, when the cylinder 130, or the piston 200, or both are tilted with respect to their central axes, the head extension part 422 may perform a rolling motion on the piston head 220 on the curved part 422a.

When the cylinder 130, or the piston 200, or both are tilted with respect to the central axes, the head extension part 422 performs a rolling motion on the piston head 220. Accordingly, the bolt body 410 that is combined with the bolt head 420 is also tilted at an angle at which the bolt body 410 has been tilted due to the rolling motion of the bolt head 420.

When the cylinder 130, or the piston 200, or both are tilted with respect to the central axes as described above, the bolt head 420 and the bolt body 410 are also tilted. Accordingly, a load can be prevented from being concentrated on only a specific ball member B, among the plurality of ball members B disposed in the length direction of the bolt body 410. Accordingly, the durability of the brake apparatus for a vehicle can be improved because the robustness of the bolt screw 400 for the tilting of the cylinder 130, or the piston 200, or both is secured.

The bearing 500 is disposed between the cylinder 130 and the nut screw 300, and may support the nut screw 300 so that the nut screw 300 is rotatable within the cylinder 130.

When the cylinder 130, or the piston 200, or both are tilted with respect to their central axes, the nut screw 300 may roll and come into contact with the bearing 500. That is, when the cylinder 130, or the piston 200, or both are tilted with respect to the central axes, the nut screw 300 may perform a rolling motion on the bearing 500.

When the cylinder 130, or the piston 200, or both are tilted with respect to the central axes as described above, the nut screw 300 is also tilted. Accordingly, the load of the nut screw 300 can be blocked from being concentrated on only a specific ball member B, among plurality of ball members B that is disposed in the length direction of the bolt body 410. Accordingly, the durability of the brake apparatus for a vehicle can be improved because the robustness of the bolt screw 400 for the tilting of the cylinder 130, or the piston 200, or both is secured.

The bearing 500 may include an outer ring 510 and a bearing ball 520.

The outer ring 510 comes into contact with the inner surface of the cylinder 130. The outer ring 510 may be firmly fixed to the cylinder 130 by being press-fitted and combined therewith. As the outer ring 510 is press-fitted and combined with the cylinder 130, a load that is applied to the bearing ball 520 can be distributed in an axial direction thereof, or an outside diameter direction thereof, or both through the outer ring 510.

The bearing ball 520 may be disposed between the outer ring 510 and the nut screw body 310. In the present embodiment, as the nut screw body 310 plays a role as an inner ring, the brake apparatus for a vehicle can be fabricated more compactly and costs can be reduced due to a reduction in the number of assembly parts because the outside diameter of the bearing 500 can be reduced.

The outer ring 510 may include a bearing ball contact portion 515, an outer ring step portion 516, and an outer ring bottom portion 517.

The outer ring 510 may have the outer ring bottom portion 517 formed in the direction of the piston head 220 and the outer ring step portion 516 formed in the direction of the nut screw tail 320 on the basis of the bearing ball contact portion 515. The outer ring step portion 516 is a portion that more protrudes toward the nut screw 300 than the outer ring bottom portion 517. The bearing ball contact portion 515 may be formed between the outer ring step portion 516 and the outer ring bottom portion 517.

The bearing ball contact portion 515 has a curved surface having a shape in which the bearing ball contact portion 515 is concaved inward, and may be formed in the entire inner circumference of the outer ring 510. The bearing ball 520 may have direct contact with the bearing ball contact portion 515 or may have indirect contact with the bearing ball contact portion 515 through another member. In the present embodiment, the bearing ball 510 may be seated on the bearing ball contact portion 515.

The bearing ball 520 that is disposed between the outer ring 510 and the nut screw body 310 includes the outermost part and the innermost part. The outermost part is a portion that belongs to the outer circumferential surface of the bearing ball 520 and that is farthest from the center of the bolt screw 400. The innermost part is a portion that belongs to the outer circumferential surface of the bearing ball 520 and that is closest to the center of the bolt screw 400.

The outer ring bottom portion 517 may have the same height as the outermost part of the bearing ball 520 or a portion of the bearing ball contact portion 515 that meets the outermost part of the bearing ball 520.

The bearing ball contact portion 515 may include an outside contact part. The outside contact part is closer to the outer ring step portion 516 than to the outer ring bottom portion 517 on the basis of the outermost part of the bearing ball 520. The bearing ball 520 may come into contact with the inner surface of the bearing ball contact portion 515 in the outside contact part.

The bearing 500 may further include a stopper 550. The stopper 550 has one side press-fitted and combined with the inner surface of the outer ring 510 and the other side extended toward the nut screw body 310. The stopper 550 is disposed in front of a nut shoulder portion 316, and restricts the nut screw body 310 from moving more than a set range. That is, as the stopper 550 is spaced apart from the nut shoulder portion 316 at a predetermined distance in front of the nut shoulder portion 316, when the nut screw body 310 is moved in the set range in the process of being relatively moved with respect to the outer ring 510, the nut shoulder portion 316 is blocked by the stopper 550 and thus a further movement thereof is blocked. Accordingly, a relative movement between the nut screw 300 and the cylinder 130 can be prevented from falling outside the set range.

The stopper 550 may be made of a metal material. In the present embodiment, the stopper 550 includes a steel material, but may be substituted with another material.

FIG. 3 illustrates a first embodiment of the stopper 550. The stopper 550 may include a combination part 551 and an extension part 552. The combination part 551 is combined with the outer ring 510. The extension part 552 extends from the combination part 551 toward the nut screw 300, and may restrict a relative movement of the nut screw 300 for the outer ring 510.

The stopper 550 has one side combined with the outer ring 510 and the other side extended toward the nut screw 300, and may restrict a movement of the nut screw 300 toward the piston 200 within a set range.

The stopper 550 has the combination part 551, that is, one end, combined with the inner surface of the outer ring 510 by using a method, such as press-fitting and combination, and has the extension part 552, that is, the other end, extended toward the nut screw body 310 so that the other end of the stopper 550 is disposed in front of the nut shoulder portion 316. As the stopper 550 is disposed in front (i.e., the left side on the basis of FIG. 3) of the nut shoulder portion 316, when the nut screw 300 is moved toward the piston 200, the nut shoulder portion 316 may come into contact with the extension part 552. As the nut shoulder portion 316 comes into contact with the extension part 552, a movement of the nut screw 300 is blocked because a forward (i.e., the left side on the basis of FIG. 3) movement of the nut shoulder portion 316 is restricted.

The nut shoulder portion 316 may include a first nut shoulder portion 316A with which the extension part 552 comes into contact and a second nut shoulder portion 316B that less protrudes toward the outer ring 510 than the first nut shoulder portion 316B. The extension part 552 is extended toward the second nut shoulder portion 316B and disposed to be spaced apart from the second nut shoulder portion 316A at a predetermined distance. In this case, the predetermined distance may be the same as the distance where a forward movement of the nut screw 300 is permitted.

As the bolt screw 400 is moved toward the piston 200, that is, forward, upon braking operation of the brake apparatus for a vehicle, the nut screw 300 may be moved to a side opposite to the side of the piston 200 by a reaction thereof. When the braking of the brake apparatus for a vehicle is released, an excessive forward movement of the nut screw 300 is blocked by the stopper 550 in a process of the nut screw 300 returning to its original state, and thus the nut screw 300 is disposed within a set range. Accordingly, the nut screw 300, or the bolt screw 400, or both can return to its regular position after a braking operation, and thus braking performance can be improved as the braking operation is performed at the regular position.

FIG. 4 illustrates a second embodiment of the stopper 550. The stopper 550 may include a combination part 551 and an extension part 552. The combination part 551 is combined with the outer ring 510. The extension part 552 extends from the combination part 551 toward the nut screw 300, and may restrict a relative movement of the nut screw 300 for the outer ring 510.

The stopper 550 has one side combined with the outer ring 510 and the other side extended toward the nut screw 300, and may restrict a movement of the nut screw 300 toward the piston 200 within a set range.

The stopper 550 has the combination part 551, that is, one end, combined with the outer surface of the outer ring 510 by using a method, such as press-fitting or combination, and the extension part 552, that is, the other end, extended toward a second nut shoulder portion 316B so that the other end of the stopper 550 is disposed in front of a first nut shoulder portion 316A. As the stopper 550 is disposed in front of the first nut shoulder portion 316A, when the nut screw 300 is moved toward the piston 200, the first nut shoulder portion 316A may come into contact with the extension part 552. As the first nut shoulder portion 316A comes into contact with the extension part 552, a movement of the nut screw 300 is blocked because a forward movement of the first nut shoulder portion 316A is restricted.

The extension part 552 is extended toward the second nut shoulder portion 316B and disposed to be spaced apart from the second nut shoulder portion 316A at a predetermined distance. In this case, the predetermined distance may be the same as the distance where a forward movement of the nut screw 300 is permitted.

Upon braking operation of the brake apparatus for a vehicle, as the bolt screw 400 is moved toward the piston 200, the nut screw 300 may be moved to a side opposite to the side of the piston 200 by a reaction thereof. When the braking of the brake apparatus for a vehicle is released, an excessive forward movement of the nut screw 300 is blocked by the stopper 550 in a process of the nut screw 300 returning to its original state, and thus the nut screw 300 is disposed within a set range. Accordingly, the nut screw 300, or the bolt screw 400, or both can return to its regular position after a braking operation, and braking performance can be improved as the braking operation is performed at the regular position.

FIG. 5 illustrates a third embodiment of the stopper 550. The stopper 550 may include a combination part 551 and an extension part 552. The combination part 551 is combined with the nut screw 300. The extension part 552 is extended from the combination part 551 to the outside thereof, and may restrict a relative movement of the nut screw 300 for the outer ring 510.

The stopper 550 has one side combined with the nut screw 300 and the other side extended toward the outside so that the other side of the stopper 550 falls outside the outer ring 510. The stopper 550 may restrict a movement of the nut screw 300 toward the piston 200 within a set range.

The stopper 550 may have the combination part 551, that is, one end, combined with a nut bottom portion 317 of the nut screw 300 that faces the outer ring 510 by using a method, such as press-fitting and combination, and may have the extension part 552, that is, the other end, extended toward the outside so that the other end of the stopper 550 is disposed in the rear of the outer ring 510. The end of the extension part 552 is extended to be disposed further outward than the outer ring step portion 516.

As the stopper 550 is disposed in the rear of the outer ring 510, when the nut screw 300 is moved toward the piston 200, the stopper 550 combined with the nut screw 300 may come into contact with the outer ring 510. As the stopper 550 is blocked by the outer ring 510, a forward movement of the nut screw 300 combined with the stopper 550 is blocked.

The extension part 552 is disposed to be spaced apart from the rear of the outer ring 510 at a predetermined distance. In this case, the predetermined distance may be the same as the distance where a forward movement of the nut screw 300 is permitted.

Upon braking operation of the brake apparatus for a vehicle, as the bolt screw 400 is moved toward the piston 200, the nut screw 300 may be moved to a side opposite to the side of the piston 200 by a reaction thereof. When the braking of the brake apparatus for a vehicle is released, an excessive forward movement of the nut screw 300 is blocked by the stopper 550 in a process of the nut screw 300 returning to its original state, and thus the nut screw 300 is disposed within a set range. Accordingly, the nut screw 300, or the bolt screw 400, or both can return to its regular position after a braking operation, and braking performance can be improved because the braking operation is performed at the regular position.

FIG. 6 illustrates a fourth embodiment of the stopper 550. The stopper 550 may include a combination part 551 and an extension part 552. The combination part 551 combined with the nut screw 300. The extension part 552 is extended from the combination part 551 toward the outside, and may restrict a relative movement of the outer ring 510 for the nut screw 300.

The stopper 550 has one side combined with the nut screw 300, specifically, a portion that is stepped from the nut bottom portion 317 and the other side extended toward the outside so that the other end of the stopper 550 falls outside the outer ring 510, and may restrict a movement of the nut screw 300 toward the piston 200 within a set range.

The stopper 550 may have one end combined with one side of the nut screw 300, which is stepped from the nut bottom portion 317, by a method, such as press-fitting and combination, and may have the extension part 552, that is, the other end, extended toward the outside so that the other end of the stopper 550 is disposed in the rear of the outer ring 510. The end of the extension part 552 is extended so that the extension part 552 is disposed further outward the outer ring step portion 516.

As the stopper 550 is disposed in the rear of the outer ring 510, when the nut screw 300 is moved toward the piston 200, the stopper 550 combined with the nut screw 300 may come into contact with the outer ring 510. As the stopper 550 is blocked by the outer ring 510, a forward movement of the nut screw 300 combined with the stopper 550 is blocked.

The extension part 552 is disposed to be spaced apart from the rear of the outer ring 510 at a predetermined distance. In this case, the predetermined distance may be the same as the distance where a forward movement of the nut screw 300 is permitted.

Upon braking operation of the brake apparatus for a vehicle, as the bolt screw 400 is moved toward the piston 200, the nut screw 300 may be moved to a side opposite to the piston 200 by a reaction thereof. When the braking of the brake apparatus for a vehicle is released, an excessive forward movement of the nut screw 300 is blocked by the stopper 550 in a process of the nut screw 300 returning to its original state, and thus the nut screw 300 is disposed within a set range. Accordingly, the nut screw 300, or the bolt screw 400, or both can return to its regular position after a braking operation, and braking performance can be improved because the braking operation is performed at the regular position.

The nut screw body 310 may include a rolling contact portion 315, a nut shoulder portion 316, and a nut bottom portion 317. The rolling contact portion 315 may be a raceway.

The nut screw body 310 has the function of an inner ring, that is, a rotation portion of the bearing 500. Accordingly, the nut screw body 310 may be rotated with respect to the outer ring 510. Furthermore, the nut screw body 310 includes the rolling contact portion 315 at a portion that faces the bearing ball 520, and may perform a rolling motion the bearing ball 520. As the nut screw body 310 can perform a rolling motion on the bearing ball 520, an angle between the nut screw body 310 and the outer ring 510 may be changed.

The nut screw body 310 may have the nut shoulder portion 316 formed in the direction of the piston head 220 and the nut bottom portion 317 formed in the direction of the nut screw tail 320 on the basis of the rolling contact portion 315. The nut shoulder portion 316 is a portion that more protrudes to the outside than the nut bottom portion 317, and thus the rolling contact portion 315 may be formed between the nut shoulder portion 316 and the nut bottom portion 317.

The rolling contact portion 315 has a curved surface having a shape in which the rolling contact portion 315 is concaved inward, and may be formed in the entire outer circumference of the nut screw body 310. The bearing ball 520 may have direct contact with the rolling contact portion 315 or may have indirect contact with the rolling contact portion 315 through another member. In the present embodiment, the bearing ball 510 may be seated on the rolling contact portion 315.

As the rolling contact portion 315 includes the curved surface portion, the nut screw body 310 may perform a rolling motion on the bearing ball 520 or the outer ring 510 on the rolling contact portion 315.

The nut shoulder portion 316 may be formed to protrude more to the outside than the innermost part of the bearing ball 520. Accordingly, the nut shoulder portion 316 may be formed to surround the innermost part of the bearing ball 520. The nut bottom portion 317 may have the same height as a portion of the rolling contact portion 315 that meets the innermost part of the bearing ball 520 or the innermost part of the bearing ball 520.

The rolling contact portion 315 may include an inside contact part. The inside contact part is closer to the nut shoulder portion 316 than to the nut bottom portion 317 on the basis of the innermost part of the bearing ball 520. The bearing ball 520 may come into contact with the inner surface of the rolling contact portion 315 in the inside contact part.

In order to generate a braking force for the brake apparatus for a vehicle, the nut screw 300 is rotated in one direction, and thus the bolt screw 400 is moved toward the piston 200. As the bearing ball 520 meets the inside contact part of the rolling contact portion 315 and the outside contact part of the bearing ball contact portion 515 in the process of the braking force for the brake apparatus for a vehicle being generated, the bearing ball 520 can stably support a load of the nut screw 300 that is applied in a direction opposite to the moving direction of the bolt screw 400.

According to the present embodiment, when a braking force for the brake apparatus for a vehicle is generated or a braking force for the brake apparatus for a vehicle is released, the bearing ball 520 of the bearing 500 may be formed as a two-point bearing that meets the inside contact part of the rolling contact portion 315 and the outside contact part of the bearing ball contact portion 515. The two-point bearing can reduce the size of the outside diameter of the assembly of the bolt screw 400 and the nut screw 300 because the assembly of the two-point bearing is simple compared to a four-point bearing and the size of a ball can be reduced.

Upon braking of the brake apparatus for a vehicle, the piston 200 may be tilted with respect to the central axis or the cylinder 130 may be tilted with respect to the central axis due to braking torque or the widening of the caliper body 100. According to the present embodiment, as the bolt head 420 can perform a rolling motion on the piston 200, a load can be prevented from being concentrated on only a specific ball member B, among the plurality of ball members B disposed on the outer surface of the bolt screw 400. Furthermore, according to the present embodiment, as the nut screw 300 can perform a rolling motion on the bearing 500, a load can be prevented from being concentrated on only a specific ball member B, among the plurality of ball members B disposed on the inner surface of the nut screw 300.

The brake apparatus for a vehicle according to the present embodiment can perform a rolling motion at a front portion of the bolt screw 400, or an outside portion of the nut screw 300, or the front portion of the bolt screw 400 and the outside portion of the nut screw 300. Accordingly, although the piston 200 is tilted with respect to the central axis or the cylinder 130 is tilted with respect to the central axis, a load can be prevented from being concentrated on a specific ball member B. Accordingly, the brake apparatus for a vehicle according to the present embodiment can improve apparatus durability while securing robustness for tilting.

The brake apparatus for a vehicle according to the first embodiment of the present disclosure may further include an actuator 600.

The actuator 600 may provide a rotational force to the nut screw 300 by receiving electric power from the motor part 660.

The actuator 600 may include a power transfer part. The power transfer part may transfer the rotational force to the nut screw 300 by being engaged with the nut screw 300. The nut screw 300 is rotated by the rotational force provided by the actuator 600, and thus the bolt screw 400 may be translationally moved.

The brake apparatus for a vehicle according to the present embodiment is a nut screw-driven type brake apparatus for a vehicle in which the nut screw 300 is first rotated by receiving the rotational force from the actuator 600 and the bolt screw 400 that is combined with the nut screw 300 by the ball member B in an electric power way is then rotated. Accordingly, according to the present embodiment, an axial direction length can be reduced compared to a bolt screw-driven type braking apparatus for a vehicle.

The power transfer part may include a plurality of gears that is sequentially engaged and combined between the motor part 660 and the nut screw 300. The power transfer part is not limited to the above construction, and may be designed and changed in various types of electric power transfer means capable of rotating the nut screw 300 by receiving a rotational force from the motor part 660.

The power transfer part may include an electric power transfer groove part 620 disposed within the actuator housing 610.

The electric power transfer groove part 620 may be disposed to surround a rotation prevention protrusion 630. The nut screw tail 320 of the nut screw 300 may be inserted into the electric power transfer groove part 620.

The electric power transfer groove part 620 may be formed in a shape corresponding to the nut screw tail 320 so that the electric power transfer groove part 620 is engaged with the nut screw tail 320. The electric power transfer groove part 620 may be formed of a non-circular groove part. The non-circular shape refers to a shape not a normal circle, and includes shapes, such as an ellipse and a polygon. In the present embodiment, the electric power transfer groove part 620 is formed of a polygonal groove part, specifically, an approximately hexagonal groove part.

Each of the nut screw tail 320 and the electric power transfer groove part 620 is formed in the non-circular shape, but is formed in the same shape or a corresponding shape. Accordingly, when the nut screw tail 320 is inserted into the electric power transfer groove part 620, the nut screw tail 320 and the electric power transfer groove part 620 are engaged with each other. Accordingly, upon operation of the actuator 600, when the electric power transfer groove part 620 is rotated, the nut screw tail 320 that is engaged with the electric power transfer groove part 620 is also rotated in the same direction. Accordingly, the rotational force of the actuator 600 can be stably transferred to the nut screw 300 without a loss.

The actuator 600 may include a rotation prevention part. The rotation prevention part may be engaged with the bolt screw 400, and may restrict the rotation of the bolt screw 400. As the nut screw 300 is rotated by a rotational force provided by the actuator 600, the bolt screw 400 is translationally moved.

The nut screw 300 and the bolt screw 400 are combined through the medium of the ball member B in an electric power way. Accordingly, the rotation of the bolt screw 400 is blocked by the rotation prevention part so that the rotation of the nut screw 300 is changed into a translational movement of the bolt screw 400.

The rotation prevention part may include the rotation prevention protrusion 630. The rotation prevention protrusion 630 is disposed within an actuator housing 610, and may protrude to the outside of the actuator housing 610. The rotation prevention protrusion 630 may be disposed within the electric power transfer groove part 620.

When the nut screw tail 320 is inserted into the electric power transfer groove part 620 and the nut screw tail 320 and the electric power transfer groove part 620 are engaged with each other, the rotation prevention protrusion 630 is inserted into a rotation prevention groove part 411 of the bolt body 410 and thus engaged therewith. As described above, according to the present embodiment, the assembly of the brake apparatus for a vehicle can be greatly improved because the transfer of electric power to the nut screw 300 and the prevention of the rotation of the bolt screw 400 can be performed by one assembly.

The rotation prevention protrusion 630 may be formed in a non-circular column shape. The non-circular shape refers to a shape not a normal circle, and includes shapes, such as an ellipse and a polygon. In the present embodiment, the rotation prevention protrusion 630 is formed to have a polygonal column, specifically, an approximately hexagonal column shape.

The rotation prevention groove part 411 may be formed in the bolt body 410 in a shape corresponding to the rotation prevention protrusion 630 so that the rotation prevention groove part 411 is engaged with the rotation prevention protrusion 630. The rotation prevention groove part 411 may be formed in a non-circular groove part. The non-circular shape refers to a shape not a normal circle, and includes shapes, such as an ellipse and a polygon. In the present embodiment, the rotation prevention groove part 411 is formed of a polygonal groove part, specifically, an approximately hexagonal groove part.

Each of the rotation prevention protrusion 630 and the rotation prevention groove part 411 is formed in the non-circular shape, but is formed in the same shape or a corresponding shape. Accordingly, when the rotation prevention protrusion 630 is inserted into the rotation prevention groove part 411, the rotation prevention protrusion 630 and the rotation prevention groove part 411 are engaged with each other. Accordingly, upon operation of the actuator 600, when the electric power transfer groove part 620 is rotated, the nut screw tail 320 that is engaged with the electric power transfer groove part 620 is rotated in the same direction, but the rotation of the bolt body 410 is blocked. Accordingly, the rotational force of the actuator 600 can be stably converted into a translational movement of the bolt screw 400 without a loss.

As the rotation prevention protrusion 630 and the rotation prevention groove part 411 come into surface contact with each other, a loss of a frictional force when a forward load in the axial direction occurs can be reduced, and the bolt body 410 can be centered. Furthermore, as the rotation prevention groove part 411 can be formed integrally with the bolt body 410, space utilization can be improved because it is not necessary to separately fabricate a rotation prevention structure.

The rotation prevention groove part 411 may include an extension inclination surface 411a that extends to the outside in order to induce the regular insertion of the rotation prevention protrusion 630. The rotation prevention protrusion 630 may include a tapered inclination part 630a on the outside of a front part thereof so that the rotation prevention protrusion 630 can be more easily inserted into the rotation prevention groove part 411.

The length in which the rotation prevention protrusion 630 is inserted into the bolt body 410 may be greater than a maximum stroke of the piston 200. The maximum stroke of the piston 200 refers to a distance where the piston 200 is moved from an original point up to a maximum advancement point. The stroke of the piston 200 may be increased by a worn amount when the brake pad 30 is worn. Accordingly, as the length where the rotation prevention protrusion 630 is inserted into the bolt body 410 is greater than the maximum stroke of the piston 200, the rotation prevention protrusion 630 maintains the state in which the rotation prevention protrusion 630 has been always engaged with the rotation prevention groove part 411 of the bolt body 410. Accordingly, the rotation of the bolt screw 400 may always be blocked.

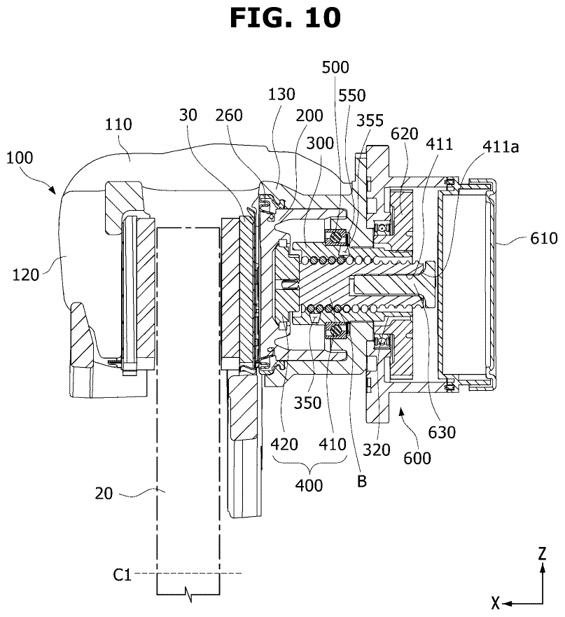

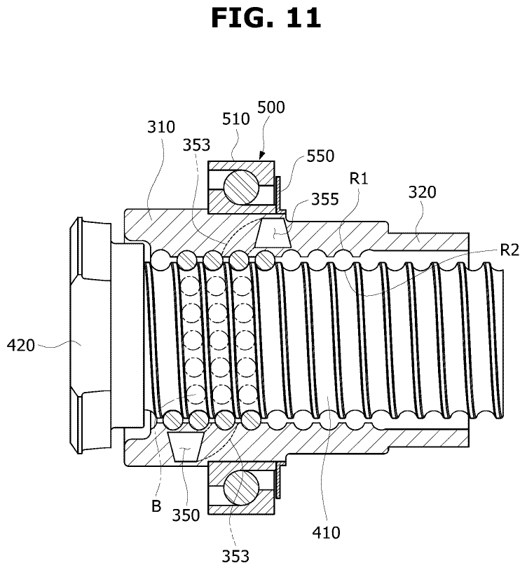

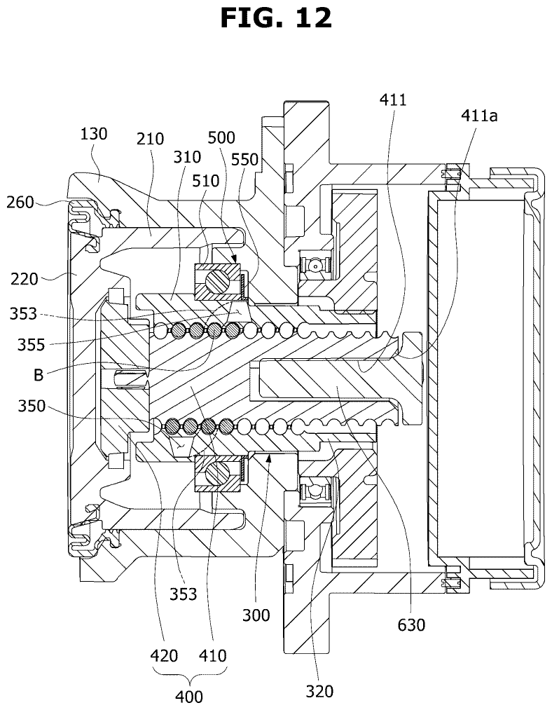

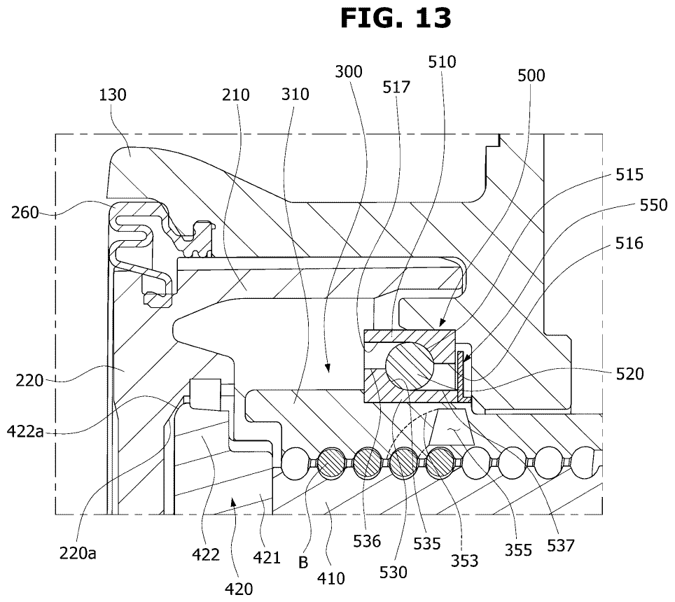

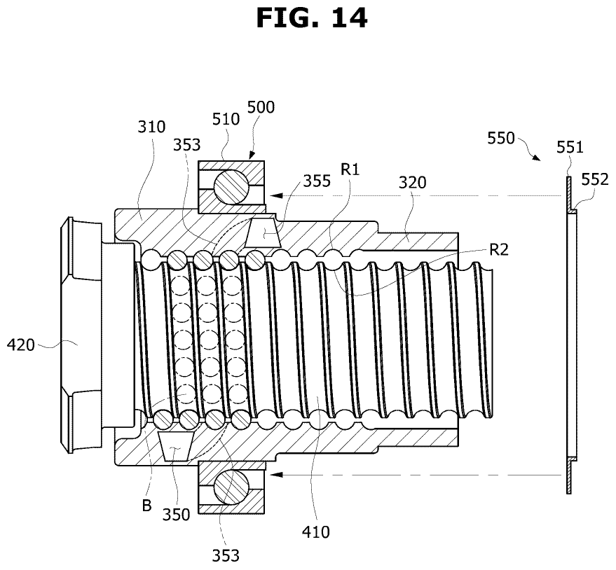

FIG. 10 is a cross-sectional view schematically illustrating a brake apparatus for a vehicle according to a second embodiment of the present disclosure. FIG. 11 is a diagram schematically illustrating the return path of a ball member in the brake apparatus for a vehicle according to the second embodiment of the present disclosure. FIG. 12 is a partially enlarged view of FIG. 10. FIG. 13 is a partially enlarged view of FIG. 12. FIG. 14 is a diagram illustrating the state in which a location fixing part is mounted on a nut screw in the brake apparatus for a vehicle according to the second embodiment of the present disclosure.

Referring to FIGS. 1 and 9 to 14, the brake apparatus for a vehicle according to the second embodiment of the present disclosure may include a caliper body 100, a piston 200, a nut screw 300, a bolt screw 400, and a bearing 500. In the first embodiment and second embodiment of the present disclosure, components to which the same reference numeral has been assigned have the same structure and function. Accordingly, hereinafter, descriptions of contents that are redundant with the contents of the first embodiment in the description of the second embodiment are omitted.

The piston 200 may include a piston body 210 and a piston head 220.

The piston body 210 is formed in a hollow column shape. The piston head 220 is connected to the piston body 210 so that the piston head 220 closes one side (i.e., the left side on the basis of FIG. 10) of the piston body 210. The piston head 220 is disposed on a side that faces a brake pad 30, among both sides of the piston body 210 that have been opened, and closes an opened area of the piston body 210.

The bolt screw 400 may be disposed within the piston 200. The bolt body 410 and bolt head 420 of the bolt screw 400 are surrounded by the piston body 210. The bolt head 420 may be disposed in the piston head 220 so that the bolt head 420 is inserted into the piston head 220.

A piston boot 260 that prevents the introduction of an external alien substance and that water-tightly seals the cylinder 130 may be installed within a cylinder 130. The piston boot 260 may be installed between the cylinder 130 and the piston 200. The piston boot 260 is combined with the piston body 210 or the piston head 220, and may be press-fitted within the cylinder 130.

The piston boot 260 may be formed to surround the piston 200. The piston boot 260 may include an elastically deformable material. For example, the piston boot 260 may be fabricated by using a rubber material. The piston boot 260 may be formed to have a ruffled shape.

The nut screw 300 is rotatably disposed in the cylinder 130, and may be combined with the bolt screw 400. The bearing 500 that rotatably supports the nut screw 300 may be installed within the cylinder 130. The bearing 500 may be a ball bearing that is disposed between the cylinder 130 and the nut screw 300.

The nut screw 300 may have a column shape in which the nut screw 300 has an empty inside and both ends opened. The nut screw 300 is disposed within the cylinder 130, and the central axis of the nut screw 300 may be placed on the same axis line as the central axis of the cylinder.

One side (i.e., the left side on the basis of FIG. 10) of the nut screw 300 may be disposed to face the inner surface (i.e., a right surface on the basis of FIG. 10) of the piston 200 by being spaced apart from the inner surface of the piston 200 at a predetermined gap. The other side (i.e., the right side on the basis of FIG. 10) of the nut screw 300 may protrude to the outside of the cylinder 130 through the cylinder 130.

The inner surface of the nut screw 300 may be disposed to face the outer surface of the bolt screw 400. An outside ball rail R1 on which a ball member B having a spherical shape is seated may be formed in the inner circumferential surface of the nut screw 300. The outside ball rail R1 extends in a spiral form in the length direction of the nut screw 300. The outside ball rail R1 of the nut screw 300 forms the circulation path of the ball member B along with an inside ball rail R2 of the bolt screw 400 on an opposite side.

The nut screw 300 receives a rotational force generated by an actuator 600 through a power transfer part when the actuator 600 operates, and may be rotated in a clockwise direction or counterclockwise direction around a central axis thereof.

The nut screw 300 may include a nut screw body 310 and a nut screw tail 320.

Most of the nut screw body 310 is disposed within the cylinder 130. Most of or the entire nut screw tail 320 may be exposed to the outside of the cylinder 130. The nut screw body 310 may be surrounded by the piston body 210.

The nut screw tail 320 may be formed in a non-circular column shape. The non-circular shape refers to a shape not a normal circle, and includes shapes, such as an ellipse and a polygon. In the present embodiment, the nut screw tail 320 is formed to have a polygonal column, specifically, an approximately hexagonal column shape.

The bolt screw 400 may be moved within the cylinder 130 in the first direction and the second direction while operating in conjunction with the rotation of the nut screw 300. The bolt screw 400 may be disposed within the nut screw 300. The bolt screw 400 may be disposed to penetrate both ends of the nut screw 300.

The bolt screw 400 is moved in the first direction, that is, a direction toward the brake pad 30, and may move the piston 200 so that the piston 200 pressurizes the brake pad 30. Furthermore, the bolt screw 400 may release pressurization for the piston 200 because the bolt screw 400 is moved in the second direction, that is, a direction opposite to the first direction.

The bolt screw 400 may include the bolt body 410 and the bolt head 420.

The bolt body 410 is combined with the nut screw 300, and may receive a rotational force from the nut screw 300. The bolt head 420 may be provided separately from the bolt body 410. The bolt body 410 may be integrated with the bolt head 420 by being press-fitted and combined with the bolt head 420. For example, the bolt body 410 may be serrated and press-fitted into the bolt head 420.

As the bolt head 420 is fabricated separately from the bolt body 410, the shape flexibility of the bolt head 420 can be improved. In particular, a shape of the bolt head 420 may be changed depending on the specifications of the brake apparatus for a vehicle. As the bolt head 420 is formed separately from the bolt body 410 which may be relatively easily standardized, customizing is easy, and a degree of freedom of design can be increased. According to the present embodiment, if the size of the piston 200 is changed, the contact diameter of the bolt head 420 can be easily changed in accordance with the change.

When the bolt body 410 is translationally moved in the first direction within the cylinder 130 while operating in conjunction with the rotation of the nut screw 300, the bolt head 420 disposed in front (i.e., the left side on the basis of FIG. 10) of the bolt body 410 pressurizes the piston 200.

The bolt body 410 may be formed in a column shape in which the bolt body 410 has an approximately circular cross section. The bolt body 410 is disposed within the cylinder 130, and may have a central axis placed on the same axis line as the central axis of the cylinder 130. The bolt body 410 may be combined with the nut screw 300 through the medium of the ball member B.

The inside ball rail R2 on which the ball member B is seated on may be formed in the outer circumferential surface of the bolt body 410. The inside ball rail R2 may extend in a spiral form in the length direction (i.e., a left and right direction on the basis of FIG. 10) of the bolt body 410 and provide the circulation path of the ball member B. Accordingly, when the nut screw 300 is rotated, the bolt body 410 may be moved in the first direction or the second direction by the circulation movement of the ball member B.

The outside ball rail R1 that is formed in the inner circumferential surface of the nut screw 300 and the inside ball rail R2 that is formed in the outer circumferential surface of the bolt body 410 may be disposed to face each other. The ball member B may have an outside portion guided by the outside ball rail R1 and an inside portion guided by the inside ball rail R2, and may be moved in a spiral form along the outside ball rail R1 and the inside ball rail R2.

The nut screw 300 may include a return path along which the ball member B on one side of each of the outside ball rail R1 and the inside ball rail R2 can be moved to the other side of each of the outside ball rail R1 and the inside ball rail R2. The return path of the nut screw 300 may include a first return hole part 350, a return passage 353, and a second return hole part 355.

The first return hole part 350 may have an inside diameter greater than the outside diameter of the ball member B so that the ball member B that moves on the outside ball rail R1 and the inside ball rail R2 can enter and exit the first return hole part 350. The first return hole part 350 may be formed to communicate with the outside ball rail R1 and the inside ball rail R2 so that the ball member B can enter or exit the first return hole part 350.

The second return hole part 355 may have an inside diameter greater than the outside diameter of the ball member B so that the ball member B that moves on the outside ball rail R1 and the inside ball rail R2 can enter and exit the second return hole part 355. The second return hole part 355 may be formed to communicate with the outside ball rail R1 and the inside ball rail R2 so that the ball member B can enter or exit the second return hole part 355. The second return hole part 355 is formed at a point different from a point at which the first return hole part 350 is formed. In the present embodiment, the first return hole part 350 may be disposed to be closer to the piston 200 than the second return hole part 355.

The return passage 353 has one side communicate with the first return hole part 350 and the other side communicate with the second return hole part 355, and connects the first return hole part 350 and the second return hole part 355. Accordingly, the ball member B that enters the first return hole part 350 may be guided into the second return hole part 355 through the return passage 353, may move to the outside ball rail R1 and the inside ball rail R2 again. The ball member B that has entered the second return hole part 355 may be guided into the first return hole part 350 through the return passage 353, and may move to the outside ball rail R1 and the inside ball rail R2 again.

The ball member B may enter and exit the first return hole part 350 and the second return hole part 355. For example, in a process of a braking force for the brake apparatus for a vehicle being generated, that is, when the bolt screw 400 is moved toward the piston 200, the ball member B may enter the first return hole part 350 and then move to the second return hole part 355. In contrast, in a process of a braking force for the brake apparatus for a vehicle being released, that is, when the bolt screw 400 is moved to a side opposite to a side on which the piston 200 is placed, the ball member B may enter the second return hole part 355 and then move to the first return hole part 350.

A process of a braking force being generated for the brake apparatus for a vehicle is basically described.

As the bolt screw 400 is moved toward the piston 200 by the rotation of the nut screw 300, when the ball member B reaches a set point, in the present embodiment, a point at which the first return hole part 350 has been formed, the ball member B enters the first return hole part 350 by the continued rotation of the nut screw 300. Thereafter, the ball member B is guided into the second return hole part 355 through the return passage 353, exits the second return hole part 355, and is then placed on the outside ball rail R1 and the inside ball rail R2. When the rotation of the nut screw 300 is continuously performed, the ball member B may move along the outside ball rail R1 and the inside ball rail R2 from a point at which the second return hole part 355 has been formed, may then reach the point at which the first return hole part 350 has been formed, and may then enter the first return hole part 350 so that the recirculation of the ball member B may continue.

A process of a braking force for the brake apparatus for a vehicle being released is basically described. As the bolt screw 400 is moved to the side opposite to the side on which the piston 200 is placed by the rotation of the nut screw 300, when the ball member B reaches the point at which the second return hole part 355 has been formed, the ball member B enters the second return hole part 355 by the continued rotation of the nut screw 300. Thereafter, the ball member B is guided into the first return hole part 350 through the return passage 353, exits the first return hole part 350, and is then placed on the outside ball rail R1 and the inside ball rail R2. When the rotation of the nut screw 300 is continuously performed, the ball member B may move along the outside ball rail R1 and the inside ball rail R2 from the point at which the first return hole part 350 has been formed, may then reach the point at which the second return hole part 355 has been formed, and may enter the second return hole part 355 again so that the recirculation of the ball member B is performed.

According to the present embodiment, the ball member B may be repeatedly moved on the outside ball rail R1 and the inside ball rail R2 because the return path is separately provided in the nut screw 300. Accordingly, durability between the nut screw 300 and the bolt screw 400 can be improved. Upon braking operation or braking release operation of the brake apparatus for a vehicle, rotation torque can be stably converted into an axial load and transferred.

The bolt head 420 may be disposed between the bolt body 410 and the piston 200. The bolt head 420 may be formed to have an approximately circular cross section. The bolt head 420 may be disposed to be inserted into the piston head 220. The bolt head 420 may be disposed to face the inner surface of the piston head 220 by being spaced apart from the inner surface of the piston head 220 at a predetermined gap. When a braking force is not generated for the brake apparatus for a vehicle or a braking force for the brake apparatus for a vehicle is released, the bolt head 420 may be disposed to be spaced apart from the piston head 220.

The bolt head 420 may pressurize the piston head 220. The bolt head 420 may pressurize the piston head 220 in the first direction in the moving direction of the bolt body 410 or may release pressurization for the piston head 220.

The outside diameter of the bolt head 420 may be greater than the outside diameter of the bolt body 410. Accordingly, when the bolt screw 400 moves the piston 200 toward the brake pad 30 by pressurizing the piston 200, the contact diameter of the bolt screw 400 that comes into contact with the piston 200 may be extended.

The contact diameter of the bolt head 420 that comes into contact with the piston head 220 is further extended when the outside diameter of the bolt head 420 is greater than the outside diameter of the bolt body 410 compared to a case in which the outside diameter of the bolt head 420 that comes into contact with the piston head 220 is equal to or smaller than the outside diameter of the bolt body 410. Accordingly, efficiency of a load transfer to the piston 200 through the bolt head 420 can be improved. Furthermore, as the contact diameter of the bolt head 420 that comes into contact with the piston head 220 is extended, a load can be stably transferred to the piston 200, and the centering of the bolt screw 400 can be stably maintained.

The bolt head 420 may include a head connection part 421 and a head extension part 422.

The head connection part 421 is a portion of the bolt head 420 toward the bolt body 410, and is combined with the bolt body 410. The head extension part 422 is extended toward the piston head 210 in the head connection part 421, and may have an outside diameter greater than the outside diameter of the head connection part 421. Accordingly, the contact diameter of the bolt screw 400 that comes into contact with the piston 200 can be extended.

The contact diameter of the head extension part 422 that comes into contact with the piston head 220 is further extended when the outside diameter of the head extension part 422 is greater than the outside diameter of the head connection part 421 compared to a case in which the outside diameter of the head extension part 422 that comes into contact with the piston head 220 is the same as the outside diameter of the head connection part 421. Accordingly, efficiency of a load transfer to the piston 200 through the bolt head 420 can be further improved. Furthermore, as the contact diameter of the head extension part 422 that comes into contact with the piston head 220 is extended, the transfer of a load to the piston 200 is performed more stably.

The head extension part 422 may include a curved part 422a on the outer circumference of the head extension part 422 toward the piston head 220.

The head extension part 422 may include the curved part 422a on the outer circumference of the head extension part 422 toward the piston head 220. The curved part 422a has a curved surface having a shape in which the curved part 422a is convexed toward the piston head 220, and may be formed in the entire outer circumference of the head extension part 422. The head extension part 422 may come into contact with the piston head 220 on the curved part 422a.

The head extension part 422 may roll and come into contact with the piston head 220 on the curved part 422a. That is, the head extension part 422 may perform a rolling motion on the piston head 220 on the curved part 422a.

The piston head 220 may include a plane part 220a at a portion that comes into contact with the curved part 422a. Accordingly, when the head extension part 422 is brought into contact with the piston head 220 by a movement of the bolt screw 400 in the first direction, although the head extension part 422 performs a rolling motion on the piston head 220, the head extension part 422 having the convex curved part 422a and the piston head 220 having the plane part 220a can maintain the contact state.

When the brake disk 20 has a friction with the brake pad 30 by a movement of the piston 200 and thus a braking force is generated, a shape of the caliper body 100 may be partially deformed by a reaction of the braking force. Accordingly, the cylinder 130 and the piston 200 may be slightly tilted with respect to a central axis compared to a non-braking state. That is, in the braking state, the cylinder 130, or the piston 200, or both may be tilted at a fine angle to the central axis.

When the cylinder 130, or the piston 200, or both are tilted with respect to their central axes, the head extension part 422 may roll and come into contact with the piston head 220 on the curved part 422a. That is, when the cylinder 130, or the piston 200, or both are tilted with respect to the central axes, the head extension part 422 may perform a rolling motion on the piston head 220 on the curved part 422a.

When the cylinder 130, or the piston 200, or both are tilted with respect to the central axes, the head extension part 422 performs a rolling motion on the piston head 220. Accordingly, the bolt body 410 that is combined with the bolt head 420 is also tilted at an angle at which the bolt body 410 has been tilted due to the rolling motion of the bolt head 420.

When the cylinder 130, or the piston 200, or both are tilted with respect to the central axes as described above, the bolt head 420 and the bolt body 410 are also tilted. Accordingly, a load can be prevented from being concentrated on only a specific ball member B., among the plurality of ball members B disposed in the length direction of the bolt body 410. Accordingly, the durability of the brake apparatus for a vehicle can be improved because the robustness of the bolt screw 400 for the tilting of the cylinder 130, or the piston 200, or both is secured.

The bearing 500 is disposed between the cylinder 130 and the nut screw 300, and may support the nut screw 300 so that the nut screw 300 is rotatable within the cylinder 130.

The bearing 500 may include an outer ring 510, a bearing ball 520, and an inner ring 530. The outer ring 510 comes into contact with the inner surface of the cylinder 130. The outer ring 510 may be firmly fixed to the cylinder 130 by being press-fitted and combined with the cylinder 130. As the outer ring 510 is press-fitted and combined with the cylinder 130, a load that is applied to the bearing ball 520 can be distributed in an axial direction thereof, or an outside diameter direction thereof, or both through the outer ring 510.

The outer ring 510 may include a bearing ball contact portion 515, an outer ring step portion 516, and an outer ring bottom portion 517.

The outer ring 510 may have the outer ring bottom portion 517 formed in the direction of the piston head 220 and the outer ring step portion 516 formed in the direction of the nut screw tail 320 on the basis of the bearing ball contact portion 515. The outer ring step portion 516 is a portion that more protrudes toward the nut screw 300 than the outer ring bottom portion 517. The bearing ball contact portion 515 may be formed between the outer ring step portion 516 and the outer ring bottom portion 517.

The bearing ball contact portion 515 has a curved surface having a shape in which the bearing ball contact portion 515 is concaved inward, and may be formed in the entire inner circumference of the outer ring 510. The bearing ball 520 may have direct contact with the bearing ball contact portion 515 or may have indirect contact with the bearing ball contact portion 515 through another member. In the present embodiment, the bearing ball 510 may be seated on the bearing ball contact portion 515.

The inner ring 530 is rotatably disposed within the outer ring 510, and may be combined with the nut screw 300. The inner ring 530 may be press-fitted and combined with the nut screw body 310. The bearing ball 520 is disposed between the outer ring 510 and the inner ring 530, and can reduce friction when the inner ring 530 is rotated.

The brake apparatus for a vehicle according to the second embodiment of the present disclosure may include a location fixing part 550. The location fixing part 550 may come into contact with and support the bearing 500 in the rear of the piston head 220 so that the location of the bearing 500 is fixed on the nut screw 300.

The location fixing part 550 may include a contact ring part 551. The contact ring part 551 may be formed in a ring shape, and may come into contact with and support the bearing 500 on the back.

The location fixing part 550 may be firmly combined with the nut screw 300 by a method, such as press-fitting and combination. When the location fixing part 550 is combined with the nut screw 300, the contact ring part 551 may be disposed to come into contact with the inner ring 530. Accordingly, the contact ring part 551 may support the inner ring 530 so that the location of the inner ring 530 is fixed on the nut screw body 310.

The contact ring part 551 may be formed to extend from a portion that faces the inner ring 530 to a portion that faces the outer ring 510. Accordingly, the contact ring part 551 may come into contact with at least a part of the outer ring 510 in addition to the inner ring 530.

The contact ring part 551 may be disposed to be spaced apart from the outer ring 510 at a predetermined distance in a direction opposite to the piston 200. Accordingly, when a braking force for the brake apparatus for a vehicle is generated, the contact ring part 551 and the outer ring 510 may be spaced apart from each other 0.1 to 0.3 mm. When the braking force is released, an additional movement of the outer ring 510 can be blocked because the outer ring 510 comes into contact with the contact ring part 551. Accordingly, braking performance can be improved because a displacement of the outer ring 510 is restricted within a set range in an operating process of the brake apparatus for a vehicle.

The location fixing part 550 may include an extension ring part 552 that is connected to the contact ring part 551. The extension ring part 552 may extend backward from the end of the inside of the contact ring part 551, that is, in the direction opposite to the piston 200.

The inner surface of the extension ring part 552 may come into contact with the nut screw body 310 by being closely attached thereto. When the location fixing part 550 is press-fitted and combined with the nut screw body 310, the inner surface of the contact ring part 551 and the inner surface of the extension ring part 552 are press-fitted and combined with the outer surface of the nut screw body 310. Accordingly, the location fixing part 550 can improve a combination force by increasing a combination area with the nut screw body 310 by the extension ring part 552.

An overall cross section of each of the contact ring part 551 and the extension ring part 552 may be formed in an approximately L shape.

The location fixing part 500 may include a metal material. In the present embodiment, the location fixing part 500 includes a steel material, but is not limited thereto and may be substituted with another metal material.

When the cylinder 130, or the piston 200, or both are tilted with respect to their central axes, the inner ring 530 or the outer ring 510 may roll and come into contact with the bearing ball 520. That is, when the cylinder 130, or the piston 200, or both are tilted with respect to the central axes, the inner ring 530 or the outer ring 510 may perform a rolling motion on the bearing ball 520.

As the inner ring 530 performs a rolling motion when the cylinder 130, or the piston 200, or both are tilted with respect to the central axes as described above, the nut screw 300 is also tilted. Accordingly, the load of the nut screw 300 can be prevented from being concentrated on only a specific ball member B, among the plurality of ball members B disposed in the length direction of the bolt body 410. Accordingly, the durability of the brake apparatus for a vehicle can be improved because the robustness of the bolt screw 400 for the tilting of the cylinder 130, or the piston 200, or both is secured.

The inner ring 530 may include a rolling contact portion 535, an upper shoulder part 536, and a lower bottom part 537.

The inner ring 530 may perform a rolling motion on the bearing ball 520 because the inner ring 530 includes the rolling contact portion 535 at a portion where the inner ring 530 faces the bearing ball 520 or the inner ring 530 comes into contact with the bearing ball 520. The outer ring 510 may perform a rolling motion on the bearing ball 520 because the outer ring 510 includes a rolling contact portion (not illustrated) at a portion where the outer ring 510 faces the bearing ball 520 or the outer ring 510 comes into contact with the bearing ball 520.

The inner ring 530 may have the upper shoulder part 536 formed in the direction of the piston head 220 and the lower bottom part 537 formed in the direction of the nut screw tail 320 on the basis of the rolling contact portion 535. The upper shoulder part 536 is a portion that protrudes outside relative to the lower bottom part 537. The rolling contact portion 535 may be formed between the upper shoulder part 536 and the lower bottom part 537.

The rolling contact portion 535 has a curved surface having a shape in which the rolling contact portion 535 is concaved inward, and may be formed in the entire outer circumference of the inner ring 530. The bearing ball 520 may come into direct contact with the rolling contact portion 535 or may have indirect contact with the rolling contact portion 535 through another member.

The nut screw body 310 may perform a rolling motion on the cylinder 130 because the rolling contact portion 535 includes the curved surface portion.

Upon braking of the brake apparatus for a vehicle, the piston 200 may be tilted with respect to the central axis or the cylinder 130 may be tilted with respect to the central axis due to braking torque or the widening of the caliper body 100. According to the present embodiment, a load can be prevented from being concentrated on only a specific ball member B, among the plurality of ball members B disposed in the outer surface of the bolt screw 400, because the bolt head 420 can perform a rolling motion the piston 200. Furthermore, according to the present embodiment, a load can be prevented from being concentrated on only a specific ball member B, among the plurality of ball members B disposed in the inner surface of the nut screw 300, because the inner ring 530 performs a rolling motion on the bearing ball 520 and thus the nut screw 300 can perform a rolling motion on the cylinder 130.

The brake apparatus for a vehicle according to the present embodiment can perform a rolling motion at a front portion of the bolt screw 400, or an outside portion of the nut screw 300, or the front portion of the bolt screw 400 and the outside portion of the nut screw 300. Accordingly, although the piston 200 is tilted with respect to the central axis or the cylinder 130 is tilted with respect to the central axis, a specific ball member B can be prevented from being subjected to an intensive load. Accordingly, the brake apparatus for a vehicle according to the present embodiment can improve apparatus durability while securing robustness for tilting.

The brake apparatus for a vehicle according to the second embodiment of the present disclosure may further include an actuator 600. A detailed description of the actuator 600 is substituted with the description of the first embodiment.

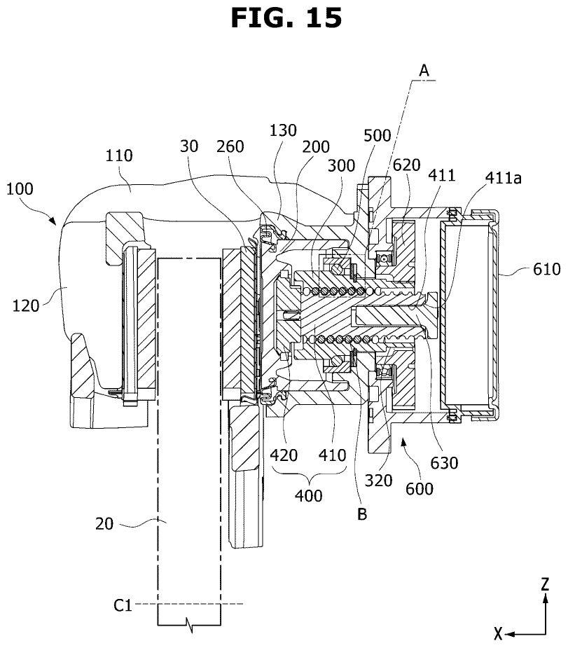

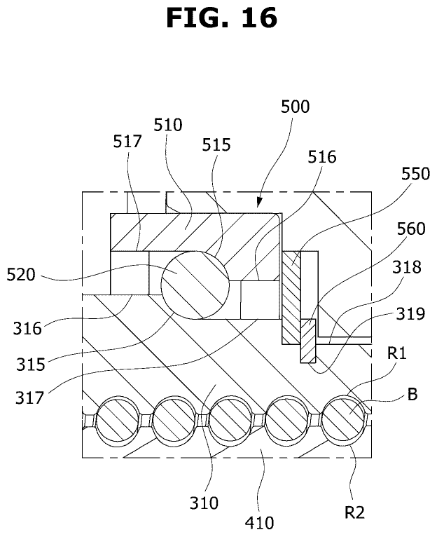

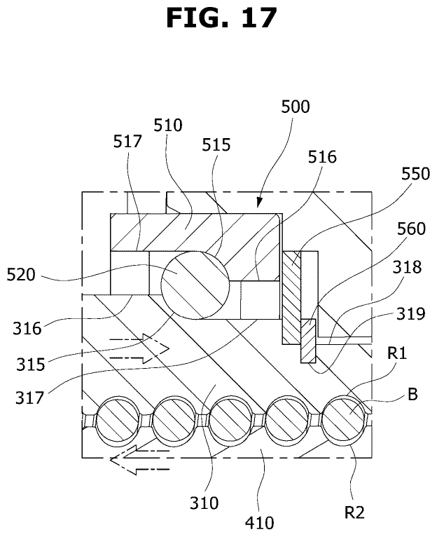

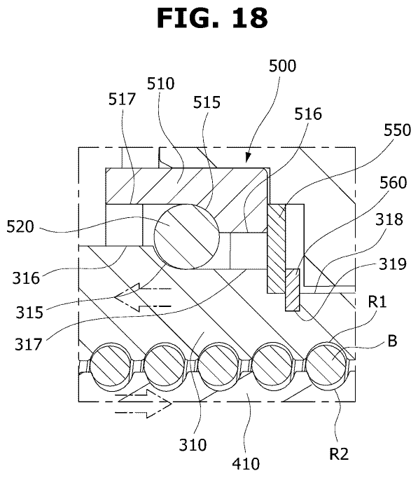

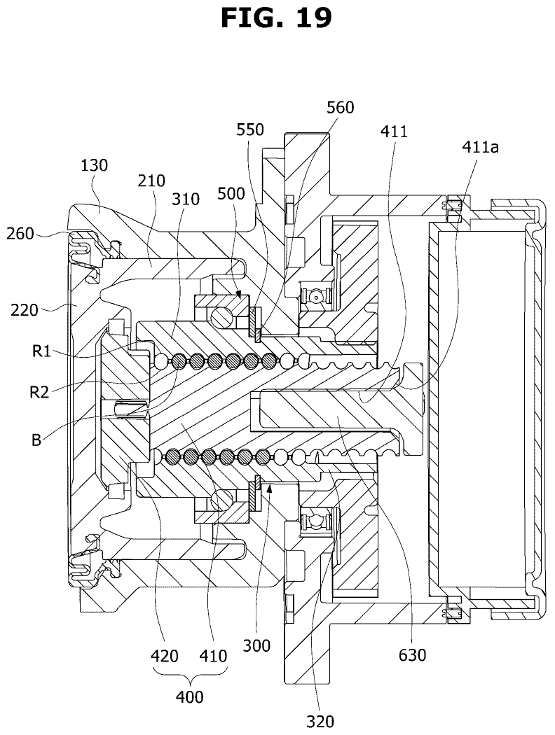

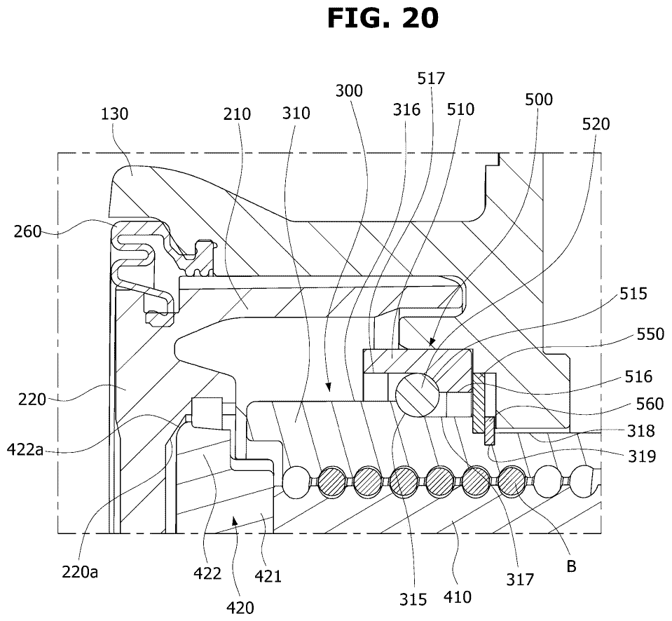

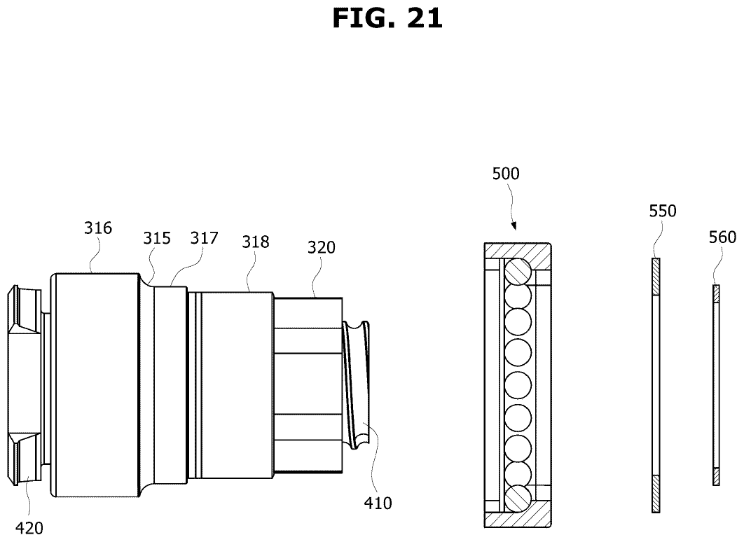

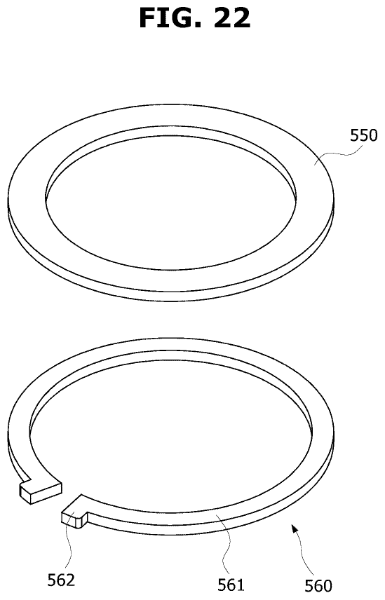

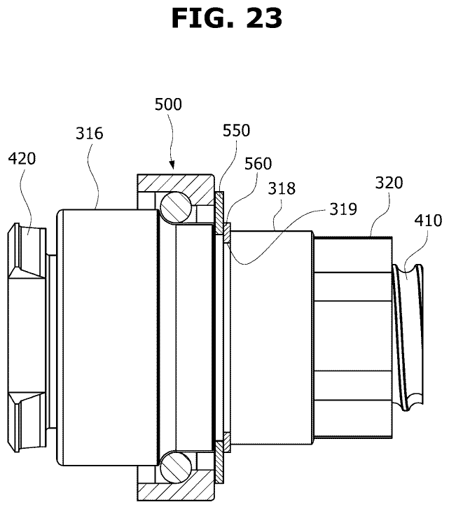

FIG. 15 is a cross-sectional view schematically illustrating a brake apparatus for a vehicle according to a third embodiment of the present disclosure. FIG. 16 is an enlarged view of a portion A in FIG. 15. FIG. 17 is a diagram illustrating a braking operation of the brake apparatus for a vehicle according to the third embodiment of the present disclosure. FIG. 18 is a diagram illustrating a braking release operation of the brake apparatus for a vehicle according to the third embodiment of the present disclosure. FIG. 19 is a partially enlarged view of FIG. 15. FIG. 20 is a partially enlarged view of FIG. 19. FIG. 21 is an exploded view illustrating a nut screw, the displacement restriction part, and the fixing part according to the third embodiment of the present disclosure. FIG. 22 is a perspective view illustrating the displacement restriction part and the fixing part according to the third embodiment of the present disclosure. FIG. 23 is a diagram illustrating that the nut screw, the displacement restriction part, and the fixing part have been combined according to the third embodiment of the present disclosure.

Referring to FIGS. 1, 9, and 15 to 23, the brake apparatus for a vehicle according to the third embodiment of the present disclosure may include a caliper body 100, a piston 200, a nut screw 300, a bolt screw 400, and a displacement restriction part 550. In the first embodiment, second embodiment, and third embodiment of the present disclosure, components to which the same reference numeral has been assigned have the same structure and function. Hereinafter, contents that are redundant with the first embodiment or the second embodiment, among descriptions of the third embodiment, are omitted.

The piston 200 may include a piston body 210 and a piston head 220.

The piston body 210 is formed in a hollow column shape. The piston head 220 is connected to the piston body 210 so that the piston head 220 closes one side (i.e., the left side on the basis of FIG. 15) of the piston body 210. The piston head 220 is disposed on a side that faces the brake pad 30, among both sides of the piston body 210 that have been opened, and closes an opened area of the piston body 210.

The bolt screw 400 may be disposed within the piston 200. The bolt body 410 and bolt head 420 of the bolt screw 400 are surrounded by the piston body 210. The bolt head 420 may be disposed to be inserted into the piston head 220.

A piston boot 260 that prevents the introduction of an external alien substance and that water-tightly seals the inside of a cylinder 130 may be installed within the cylinder 130. The piston boot 260 may be installed between the cylinder 130 and the piston 200. The piston boot 260 is combined with the piston body 210 or the piston head 220, and may be press-fitted within the cylinder 130.

The piston boot 260 may be formed to surround the piston 200. The piston boot 260 may include an elastically deformable material. For example, the piston boot 260 may be fabricated by using a rubber material. The piston boot 260 may be formed to have a ruffled shape.

The nut screw 300 is rotatably disposed in the cylinder 130, and may be combined with the bolt screw 400. The bearing 500 that rotatably supports the nut screw 300 may be installed within the cylinder 130. The bearing 500 may be a ball bearing that is disposed between the cylinder 130 and the nut screw 300.

The nut screw 300 may have a column shape in which the nut screw 300 has an empty inside and both ends opened. The nut screw 300 is disposed within the cylinder 130, and may have a central axis placed on the same axis line as the central axis of the cylinder.

One side (i.e., the left side on the basis of FIG. 15) of the nut screw 300 may be disposed to face the inner surface (i.e., a right surface on the basis of FIG. 15) of the piston 200 by being spaced apart from the inner surface of the piston 200 at a predetermined gap. The other side (i.e., the right side on the basis of FIG. 15) of the nut screw 300 may protrude to the outside of the cylinder 130 through the cylinder 130.

The inner surface of the nut screw 300 may be disposed to face the outer surface of the bolt screw 400. An outside ball rail R1 on which a ball member B having a spherical shape is seated on may be formed in the inner circumferential surface of the nut screw 300. The outside ball rail R1 extends in a spiral form in the length direction of the nut screw 300. The outside ball rail R1 of the nut screw 300 forms the circulation path of the ball member B along with an inside ball rail R2 of the bolt screw 400 on an opposite side.

The nut screw 300 receives a rotational force generated by an actuator 600 through a power transfer part when the actuator 600 operates, and may be rotated in a clockwise direction or a counterclockwise direction around a central axis thereof.

The nut screw 300 may include a nut screw body 310 and a nut screw tail 320.

Most of the nut screw body 310 is disposed within the cylinder 130. Most of or the entire nut screw tail 320 may be exposed to the outside of the cylinder 130. The nut screw body 310 may be surrounded by the piston body 210.

The nut screw tail 320 may be formed in a non-circular column shape. The non-circular shape refers to a shape not a normal circle, and includes shapes, such as an ellipse and a polygon. In the present embodiment, the nut screw tail 320 is formed to have a polygonal column, specifically, an approximately hexagonal column shape.

The bolt screw 400 may be moved in the first direction and the second direction within the cylinder 130 while operating in conjunction with the rotation of the nut screw 300. The bolt screw 400 may be disposed within the nut screw 300. The bolt screw 400 may be disposed to penetrate both ends of the nut screw 300.

The bolt screw 400 is moved in the first direction, that is, a direction toward the brake pad 30, and may move the piston 200 so that the piston 200 pressurizes the brake pad 30. Furthermore, the bolt screw 400 may release pressurization for the piston 200 as the bolt screw 400 moves in the second direction, that is, a direction opposite to the first direction.

The bolt screw 400 may include the bolt body 410 and the bolt head 420.

The bolt body 410 is combined with the nut screw 300, and may receive a rotational force from the nut screw 300. The bolt head 420 may be connected to the bolt body 410.

As illustrated in FIG. 19, the bolt head 420 may be provided separately from the bolt body 410. The bolt body 410 may be integrated with the bolt head 420 by being press-fitted and combined with the bolt head 420. For example, the bolt body 410 may be serrated and press-fitted in the bolt head 420. As the bolt head 420 is fabricated separately from the bolt body 410, the shape flexibility of the bolt head 420 can be improved. A shape of the bolt head 420 may be changed depending on the specifications of the brake apparatus for a vehicle. As the bolt head 420 is formed separately from the bolt body 410 which may be relatively easily standardized, customizing is easy and a degree of freedom of design can be improved. According to the present embodiment, if the size of the piston 200 is changed, the contact diameter of the bolt head 420 can be easily changed in accordance with the change.

FIG. 19 illustrates the construction in which the bolt body 410 and the bolt head 420 are formed as separate members and are integrated by a method, such as press-fitting and combination, but this is merely one embodiment and the present disclosure is not limited thereto. Accordingly, the bolt head 420 may be formed integrally with the bolt body 410 without being formed as a separate member. That is, the bolt head 420 and the bolt body 410 may be formed as a single member.

When the bolt body 410 is translationally moved in the first direction within the cylinder 130 while operating in conjunction with the rotation of the nut screw 300, the bolt head 420 disposed in front (i.e., the left side on the basis of FIG. 15) of the bolt body 410 pressurizes the piston 200.

The bolt body 410 may be formed in a column shape in which the bolt body 410 has an approximately circular cross section. The bolt body 410 is disposed within the cylinder 130, may have a central axis placed on the same axis line as the central axis of the cylinder 130. The bolt body 410 may be combined with the nut screw 300 through the medium of the ball member B.

The inside ball rail R2 on which the ball member B is seated may be formed in the outer circumferential surface of the bolt body 410. The inside ball rail R2 extends in a spiral form in the length direction (i.e., the left and right direction on the basis of FIG. 15) of the bolt body 410, and may provide the circulation path of the ball member B. Accordingly, when the nut screw 300 is rotated, the bolt body 410 may be moved in the first direction or the second direction by a circulation movement of the ball member B.

The outside ball rail R1 formed in the inner circumferential surface of the nut screw 300 and the inside ball rail R2 formed in the outer circumferential surface of the bolt body 410 may be disposed to face each other. The ball member B may have an outside portion guided by the outside ball rail R1 and an inside portion guided by the inside ball rail R2, and may be moved in a spiral form along the outside ball rail R1 and the inside ball rail R2.

The bolt head 420 may be disposed between the bolt body 410 and the piston 200. The bolt head 420 may be formed to have an approximately circular cross section. The bolt head 420 may be disposed to be inserted into the piston head 220. The bolt head 420 may be disposed to face the inner surface of the piston head 220 by being spaced apart from the inner surface of the piston head 220 at a predetermined gap. When a braking force is not generated for the brake apparatus for a vehicle or a braking force for the brake apparatus for a vehicle is released, the bolt head 420 may be disposed to be spaced apart from the piston head 220.

The bolt head 420 may pressurize the piston head 220. The bolt head 420 may pressurize the piston head 220 in the first direction in the moving direction of the bolt body 410 or may release pressurization for the piston head 220.

The outside diameter of the bolt head 420 may be greater than the outside diameter of the bolt body 410. Accordingly, when the bolt screw 400 moves the piston 200 toward the brake pad 30 by pressurizing the piston 200, the contact diameter of the bolt screw 400 that comes into contact with the piston 200 may be extended.

The contact diameter of the bolt head 420 that comes into contact with the piston head 220 is further extended when the outside diameter of the bolt head 420 is greater than the outside diameter of the bolt body 410 compared to a case in which the outside diameter of the bolt head 420 that comes into contact with the piston head 220 is equal to or smaller than the outside diameter of the bolt body 410. Accordingly, efficiency of a load transfer to the piston 200 through the bolt head 420 can be improved. Furthermore, as the contact diameter of the bolt head 420 that comes into contact with the piston head 220 is extended, a load to the piston 200 can be stably transferred and the centering of the bolt screw 400 can be stably maintained.

The bolt head 420 may include a head connection part 421 and a head extension part 422.

The head connection part 421 is a portion of the bolt head 420 toward the bolt body 410, and is combined with the bolt body 410. The head extension part 422 is extended toward the piston head 210 in the head connection part 421, and may have an outside diameter greater than the outside diameter of the head connection part 421. Accordingly, the contact diameter of the bolt screw 400 that comes into contact with the piston 200 can be extended.

The contact diameter of the head extension part 422 that comes into contact with the piston head 220 is further extended when the outside diameter of the head extension part 422 is greater than the outside diameter of the head connection part 421 compared to a case in which the outside diameter of the head extension part 422 that comes into contact with the piston head 220 is the same as the outside diameter of the head connection part 421. Accordingly, efficiency of a load transfer to the piston 200 through the bolt head 420 can be further improved. Furthermore, as the contact diameter of the head extension part 422 that comes into contact with the piston head 220 is extended, the transfer of a load to the piston 200 is performed more stably.

The head extension part 422 may include a curved part 422a on the outer circumference of the head extension part 422 toward the piston head 220. The curved part 422a has a curved surface having a shape in which the curved part 422a is convexed toward the piston head 220, and may be formed in the entire outer circumference of the head extension part 422. The head extension part 422 may come into contact with the piston head 220 in the curved part 422a. The head extension part 422 may roll and come into contact with the piston head 220 in the curved part 422a. That is, the head extension part 422 can perform a rolling motion on the piston head 220 in the curved part 422a.

The piston head 220 may include a plane part 220a at a portion of the piston head 220 that comes into contact with the curved part 422a. Accordingly, when the head extension part 422 is brought into contact with the piston head 220 by a movement of the bolt screw 400 in the first direction, although the head extension part 422 performs a rolling motion on the piston head 220, the head extension part 422 having the convex curved part 422a and the piston head 220 having the plane part 220a can maintain the contact state.

When a braking force is generated because the brake disk 20 has a friction with the brake pad 30 by a movement of the piston 200, a shape of the caliper body 100 may be partially deformed by a reaction of the braking force. Accordingly, the cylinder 130 and the piston 200 may be slightly tilted with respect to their central axes compared to the non-braking state. That is, in the braking state, the cylinder 130, or the piston 200, or both may be tilted at a fine angle to the central axis.

When the cylinder 130, or the piston 200, or both are tilted with respect to their central axes, the head extension part 422 may roll and come into contact with the piston head 220 on the curved part 422a. That is, when the cylinder 130, or the piston 200, or both are tilted with respect to the central axes, the head extension part 422 may perform a rolling motion on the piston head 220 on the curved part 422a.

The bolt body 410 combined with the bolt head 420 is also tilted at an angle at which the bolt body 410 is tilted by the rolling motion of the bolt head 420 because the head extension part 422 performs the rolling motion on the piston head 220 when the cylinder 130, or the piston 200, or both are tilted with respect to the central axes.

When the cylinder 130, or the piston 200, or both are tilted with respect to the central axes as described above, the bolt head 420 and the bolt body 410 are also tilted. Accordingly, a load can be prevented from being concentrated on only a specific ball member B, among the plurality of ball members B disposed in the length direction of the bolt body 410. Accordingly, the durability of the brake apparatus for a vehicle can be improved because the robustness of the bolt screw 400 for the tilting of the cylinder 130, or the piston 200, or both is secured.

The bearing 500 is disposed between the cylinder 130 and the nut screw 300, and may support the nut screw 300 so that the nut screw 300 is rotated within the cylinder 130.

When the cylinder 130, or the piston 200, or both are tilted with respect to their central axes, the nut screw 300 may roll and come into contact with the bearing 500. That is, when the cylinder 130, or the piston 200, or both are tilted with respect to the central axes, the nut screw 300 may perform a rolling motion on the bearing 500.

The nut screw 300 is also tilted when the cylinder 130, or the piston 200, or both are tilted with respect to the central axes as described above. The load of the nut screw 300 can be prevented from being concentrated on only a specific ball member B, among the plurality of ball members B disposed in the length direction of the bolt body 410. Accordingly, the durability of the brake apparatus for a vehicle can be improved because the robustness of the bolt screw 400 for the tilting of the cylinder 130, or the piston 200, or both is secured.

The bearing 500 may include an outer ring 510 and a bearing ball 520.

The outer ring 510 comes into contact with the inner surface of the cylinder 130. The outer ring 510 may be firmly fixed to the cylinder 130 by being press-fitted and combined with the cylinder 130. A load that is applied to the bearing ball 520 can be distributed in an axial direction thereof, or an outside diameter direction thereof, or both through the outer ring 510 because the outer ring 510 is press-fitted and combined with the cylinder 130.

The bearing ball 520 may be disposed between the outer ring 510 and the nut screw body 310. In the present embodiment, the outside diameter of the bearing 500 can be reduced because the nut screw body 310 plays a role as an inner ring. Accordingly, the brake apparatus for a vehicle can be fabricated more compactly and costs can be reduced due to a reduction in the number of assembly parts.

The outer ring 510 may include a bearing ball contact portion 515, an outer ring step portion 516, and an outer ring bottom portion 517. The outer ring 510 may have the outer ring bottom portion 517 formed in the direction of the piston head 220 and the outer ring step portion 516 formed in the direction of the nut screw tail 320 on the basis of the bearing ball contact portion 515. The outer ring step portion 516 is a portion that more protrudes toward the nut screw 300 than the outer ring bottom portion 517. The bearing ball contact portion 515 may be formed between the outer ring step portion 516 and the outer ring bottom portion 517.

The bearing ball contact portion 515 has a curved surface having a shape in which the bearing ball contact portion 515 is concaved inward, and may be formed in the entire inner circumference of the outer ring 510. The bearing ball 520 may have direct contact with the bearing ball contact portion 515 or may have indirect contact with the bearing ball contact portion 515 through another member. In the present embodiment, the bearing ball 510 may be seated on the bearing ball contact portion 515.

The bearing ball 520 that is disposed between the outer ring 510 and the nut screw body 310 includes the outermost part and the innermost part. The outermost part is a portion that belongs to the outer circumferential surface of the bearing ball 520 and that is farthest from the center of the bolt screw 400. The innermost part is a portion that belongs to the outer circumferential surface of the bearing ball 520 and that is closest to the center of the bolt screw 400.

The outer ring bottom portion 517 may have the same height as the outermost part of the bearing ball 520 or a portion of the bearing ball contact portion 515 that meets the outermost part of the bearing ball 520.

The bearing ball contact portion 515 may include an outside contact part. The outside contact part is closer to the outer ring step portion 516 than to the outer ring bottom portion 517 on the basis of the outermost part of the bearing ball 520. The bearing ball 520 may come into contact with the inner surface of the bearing ball contact portion 515 in the outside contact part.

The nut screw body 310 may include a rolling contact portion 315, a nut shoulder portion 316, a nut bottom portion 317, and a nut bottom shoulder part 318. The rolling contact portion 315 may be a raceway.

The nut screw body 310 may be rotated with respect to the outer ring 510 because the nut screw body 310 has the function of an inner ring, that is, a rotation portion of the bearing 500. The nut screw body 310 may perform a rolling motion on the bearing ball 520 because the nut screw body 310 includes the rolling contact portion 315 at a portion that faces the bearing ball 520. An angle between the nut screw body 310 and the outer ring 510 may be changed because the nut screw body 310 can perform a rolling motion the bearing ball 520.

The nut screw body 310 may have the nut shoulder portion 316 formed in the direction of the piston head 220 and the nut bottom portion 317 formed in the direction of the nut screw tail 320 on the basis of the rolling contact portion 315. The nut shoulder portion 316 is a portion that more protrudes to the outside than the nut bottom portion 317. The rolling contact portion 315 may be formed between the nut shoulder portion 316 and the nut bottom portion 317.

The rolling contact portion 315 has a curved surface having a shape in which the rolling contact portion 315 is concaved inward, and may be formed in the entire circumference of the outer surface of the nut screw body 310. The bearing ball 520 may have direct contact with the rolling contact portion 315 or may have indirect contact with the rolling contact portion 315 through another member. The bearing ball 510 may be seated on the rolling contact portion 315. The nut screw body 310 may perform a rolling motion on the bearing ball 520 or the outer ring 510 on the rolling contact portion 315 because the rolling contact portion 315 includes the curved surface portion.

The nut shoulder portion 316 may be formed to more protrude to the outside than the innermost part of the bearing ball 520. Accordingly, the nut shoulder portion 316 may be formed to surround the innermost part of the bearing ball 520.

The nut bottom portion 317 may have the same height as a portion of the rolling contact portion 315 that meets the innermost part of the bearing ball 520 or the innermost part of the bearing ball 520.

The nut bottom shoulder part 318 is connected to the nut bottom portion 317 and disposed on a side opposite to the nut shoulder portion 316. A stepped part, that is, a stepped part, is provided at a connection portion of the nut bottom portion 317 and the nut bottom shoulder part 318 because the outside diameter of the nut bottom shoulder part 318 is smaller than the nut bottom portion 317.

The rolling contact portion 315 may include an inside contact part. The inside contact part is closer to the nut shoulder portion 316 than to the nut bottom portion 317 on the basis of the innermost part of the bearing ball 520. The bearing ball 520 may come into contact with the inner surface of the rolling contact portion 315 in the inside contact part.

In order to generate a braking force for the brake apparatus for a vehicle, the nut screw 300 is rotated in one direction. Accordingly, the bolt screw 400 is moved toward the piston 200. As the bearing ball 520 meets the inside contact part of the rolling contact portion 315 and the outside contact part of the bearing ball contact portion 515 in the process of the braking force for the brake apparatus for a vehicle being generated, the bearing ball 520 can stably support the load of the nut screw 300 that is applied in a direction opposite to the moving direction of the bolt screw 400.

According to the present embodiment, when a braking force for the brake apparatus for a vehicle is generated or a braking force for the brake apparatus for a vehicle is released, the bearing 500 may include a two-point contact ball bearing in which the bearing ball 520 meets the inside contact part of the rolling contact portion 315 and the outside contact part of the bearing ball contact portion 515. The outside diameter of the assembly of the bolt screw and the nut screw can be reduced because the two-point contact ball bearing can reduce the diameter of a ball compared to the four-point contact ball bearing. Accordingly, production costs can be reduced because an assembly process is simplified.

The displacement restriction part 550 may be press-fitted and combined with the nut screw 300 so that the bearing 500 and the nut screw 300 are combined and are disposed in the rear of the bearing 500 simultaneously or sequentially. Thereafter, a fixing part 560 is inserted and mounted on the fixing groove part 319 so that the fixing part 560 can support the rear surface of the displacement restriction part 550.

When the brake apparatus for a vehicle performs braking, the piston 200 may be tilted with respect to the central axis or the cylinder 130 may be tilted with respect to the central axis due to braking torque or the widening of the caliper body 100. According to the present embodiment, a load can be prevented from being concentrated on only a specific ball member B, among the plurality of ball members B disposed in the outer surface of the bolt screw 400, because the bolt head 420 can perform a rolling motion the piston 200. Furthermore, according to the present embodiment, a load can be prevented from being concentrated on only a specific ball member B, among the plurality of ball members B disposed in the inner surface of the nut screw 300, because the nut screw 300 can perform a rolling motion on the bearing 500.

The brake apparatus for a vehicle according to the present embodiment can perform a rolling motion at a front portion of the bolt screw 400, or an outside portion of the nut screw 300, or the front portion of the bolt screw 400 and the outside portion of the nut screw 300. Accordingly, although the piston 200 is tilted with respect to the central axis or the cylinder 130 is tilted with respect to the central axis, a specific ball member B can be prevented from being subjected to an intensive load. Accordingly, the brake apparatus for a vehicle according to the present embodiment can improve apparatus durability while securing robustness for tilting.

The displacement restriction part 550 is mounted on the outer surface of the nut screw 300, and restricts a relative movement of the nut screw 300 for the bearing 500. The displacement restriction part 550 may have one side mounted on the outer surface of the nut screw body 310 and the other side extended toward the inner surface of the cylinder 130. The displacement restriction part 550 restricts a movement of the nut screw 300 toward the piston 200 within a set range. That is, the displacement restriction part 550 permits the nut screw 300 to move toward the piston 200, but blocks the nut screw 300 from moving more than a set range.

The displacement restriction part 550 may include a metal material. In the present embodiment, the displacement restriction part 550 includes a steel material, but may be substituted with a material including a plastic material.

The displacement restriction part 550 may be formed in a ring shape. For example, the displacement restriction part 550 may be formed in an O ring shape. An inner circumferential part of the displacement restriction part 550 may be disposed in the stepped part of the nut screw 300. The stepped part of the nut screw 300 may be provided at a connection portion of the nut bottom portion 317 and the nut bottom shoulder part 318.

The displacement restriction part 550 may have the inner circumferential part mounted on the outer surface of the nut bottom shoulder part 318 by a method, such as press-fitting and combination, and may be disposed at the connection portion of the nut bottom portion 317 and the nut bottom shoulder part 318 in a way to be closely attached to the connection portion. Accordingly, the displacement restriction part 550 can be prevented from moving on the nut bottom shoulder part 318.

The brake apparatus for a vehicle according to the third embodiment of the present disclosure may further include a fixing part 560. The fixing part 560 comes into contact with and supports the nut screw 300 so that the location of the displacement restriction part 550 is fixed on the nut screw 300. In the present embodiment, a front surface (i.e., the left surface on the basis of FIG. 20) of the displacement restriction part 550 comes into contact with and supports the stepped part of the nut bottom portion 317 and the nut bottom shoulder part 318. A rear surface (i.e., the right surface on the basis of FIG. 20) of the displacement restriction part 550 comes into contact with and supports the fixing part 560. Accordingly, the displacement restriction part 550 can be fixed on the nut bottom shoulder part 318 more firmly.

The fixing part 560 may be inserted and mounted on a fixing groove part 319 that is formed along the circumference of the nut bottom shoulder part 318. The fixing part 560 can come into contact with and support the displacement restriction part 550 more firmly because the fixing part 560 is in the state in which the fixing part 560 has been inserted into the fixing groove part 319 and the location of the fixing part 560 has been fixed.

The fixing part 560 is formed in a C ring shape, and may include an elastically deformable material. The fixing part 560 may include a fixing body 561 and reinforcement protrusions 562. The fixing body 561 is formed in a C ring shape. Both ends of the fixing body 561 are disposed to be spaced apart from each other. The reinforcement protrusions 562 protrude to the outside from both ends of the fixing body 561.

A worker can easily mount the fixing body 561 on the fixing groove part 319 by spreading both ends of the fixing body 561 beyond its original state because the fixing body 561 includes the elastically deformable material. Thereafter, as the fixing body 561 returns to the original state, the fixing body 561 can maintain the state in which the fixing body 561 has been inserted and mounted on the fixing groove part 319.

A support force for the displacement restriction part 550 may be smaller than that for another portion by the amount that both ends of the fixing body 561 have been spaced apart from each other because both ends of the fixing body 561 are disconnected and spaced apart from each other. Accordingly, the reinforcement protrusions 562 that reinforce the support force for the displacement restriction part 550 may be provided at both ends of the fixing body 561. Both ends of the fixing body 561 can secure the support force for the displacement restriction part 550 as much as another portion because a contact area with the displacement restriction part 550 is increased by the reinforcement protrusions 562. Accordingly, the fixing part 560 can uniformly support the displacement restriction part 550 360 degrees.

The displacement restriction part 550 may have an inner circumferential part press-fitted and combined with the outer surface of the nut bottom shoulder part 318 and an outer circumferential part extended toward the outside so that the displacement restriction part 550 is disposed in the rear of the outer ring 510. The outer circumferential part of the displacement restriction part 550 is extended to be more outward than the outer ring step portion 516.

The displacement restriction part 550 combined with the nut screw 300 may come into contact with the outer ring 510 when the nut screw 300 is moved toward the piston 200 because the displacement restriction part 550 is disposed in the rear of the outer ring 510. As the displacement restriction part 550 is blocked by the outer ring 510, a forward movement of the nut screw 300 combined with the displacement restriction part 550 is blocked. Accordingly, a relative movement between the nut screw 300 and the cylinder 130 can be prevented from falling outside a set range.

The outer circumferential part of the displacement restriction part 550 is disposed to be spaced apart from the rear surface of the outer ring 510 at a predetermined distance. In this case, the predetermined distance may be the same as the distance where the forward movement of the nut screw 300 is permitted.

As illustrated in FIG. 17, upon braking operation of the brake apparatus for a vehicle, as the bolt screw 400 is moved toward the piston 200, the nut screw 300 may be minutely moved to a side opposite to the piston 200 by a reaction thereof. A driving loss attributable to the contact of the displacement restriction part 550 and the bearing 500 can be prevented because the displacement restriction part 550 and the bearing 500 are spaced apart from each other. That is, upon high torque rotation of the nut screw 300, braking efficiency can be prevented from being degraded due to contact resistance because the displacement restriction part 550 and the bearing 500 do not come into contact with each other.

As illustrated in FIG. 18, upon braking release of the brake apparatus for a vehicle, the nut screw 300 may be relatively moved in an opposite direction as the bolt screw 400 is moved backward. In a process of the nut screw 300 being returned to its original state, an excessive forward movement of the nut screw 300 is blocked by the displacement restriction part 550 and disposed within a set range (refer to FIG. 18). As the nut screw 300, or the bolt screw 400, or both returns to their regular positions after a braking operation, zero drag can be implemented. A braking operation is started in the state in which the nut screw 300, or the bolt screw 400, or both have been disposed at their regular positions. Accordingly, braking performance can be improved because precise control is possible.

The brake apparatus for a vehicle according to the third embodiment of the present disclosure may further include an actuator 600, and a detailed description thereof is substituted with the description in the first embodiment.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A brake apparatus for a vehicle, comprising:
a caliper body comprising a cylinder;
a piston movably disposed in the cylinder and disposed to face a brake pad;
a nut screw disposed within the piston and configured to be rotated based on a rotational force received from an actuator;
a bolt screw comprising a bolt body combined with the nut screw and configured to receive a rotational force from the nut screw and a bolt head provided separately from the bolt body, combined with the bolt body, and disposed to face the piston;
a bearing comprising an outer ring configured to come into contact with an inner surface of the cylinder and a bearing ball disposed between the outer ring and the nut screw; and
a stopper combined with the outer ring and configured to restrict a relative movement of the nut screw for the outer ring.

2. The braking apparatus of claim 1, wherein the stopper has a first side combined with the outer ring and a second side extended toward the nut screw and configured to restrict a movement of the nut screw toward the piston within a set range.

3. The braking apparatus of claim 2, wherein:
the stopper has a first end combined with an inner surface of the outer ring and a second end disposed in front of a nut shoulder portion of the nut screw, and
wherein, in response to the nut screw is moved toward the piston, the movement of the nut screw is configured to be blocked at a position that the nut shoulder portion comes into contact with the stopper.

4. The braking apparatus of claim 2, wherein:
the stopper has a first end combined with an outer surface of the outer ring and a second end disposed in front of a nut shoulder portion of the nut screw, and
wherein, in response to the nut screw is moved toward the piston, the movement of the nut screw is configured to be blocked at a position that the nut shoulder portion comes into contact with the stopper.

5. The braking apparatus of claim 1, wherein the stopper has a first side combined with the nut screw and a second side extended toward an outside and configured to restrict a movement of the nut screw toward the piston within a set range.

6. The braking apparatus of claim 5, wherein:
the stopper has a first end combined with a nut bottom portion of the nut screw that faces the outer ring and a second end disposed in a rear of the outer ring, and
wherein, in response to the nut screw is moved toward the piston, the movement of the nut screw is configured to be blocked at a position that the stopper comes into contact with the outer ring.

7. The braking apparatus of claim 5, wherein:
the stopper has a first end combined with a nut bottom portion and stepped part of the nut screw and a second end disposed in a rear of the outer ring, and
wherein, in response to the nut screw is moved toward the piston, the movement of the nut screw is configured to be blocked at a position that the stopper comes into contact with the outer ring.

8. The braking apparatus of claim 1, wherein the bolt head comprises:
a head connection part combined with the bolt body and configured to have an outside diameter of the head connection part greater than an outside diameter of the bolt body; and
a head extension part extended from the head connection part toward the piston and configured to have an outside diameter of the head extension part greater than the outside diameter of the head connection part.

9. The braking apparatus of claim 8, wherein:
the head extension part comprises a curved part disposed in an outer circumference of the head extension part toward the piston, and
the head extension part is configured to come into contact with the piston on the curved part.

10. The braking apparatus of claim 9, wherein in response to the piston is tilted with respect to a central axis, the head extension part is configured to perform a rolling motion on the piston in the curved part, and the nut screw is configured to perform a rolling motion on the bearing.

11. A brake apparatus for a vehicle, comprising:
a caliper body including a cylinder;
a piston movably disposed in the cylinder and disposed to face a brake pad;
a nut screw disposed within the piston, configured to be rotated based on a rotational force received from an actuator, and comprising an outside ball rail configured to form a circulation path of a ball member in an inner circumferential surface thereof;
a bolt screw comprising a bolt body combined with the nut screw and configured to receive a rotational force from the nut screw and a bolt head provided separately from the bolt body, combined with the bolt body, and disposed to face the piston, wherein an inside ball rail disposed to face the outside ball rail and configured to form the circulation path of the ball member is provided in an outer circumferential surface of the bolt body;
a bearing disposed between the cylinder and the nut screw and configured to support the nut screw so that the nut screw is rotatable within the cylinder; and
a location fixing part configured to come into contact with and support the bearing so that a location of the bearing is fixed on the nut screw,
wherein the nut screw comprises a first return hole part through which the ball member is configured to enter and exit, a return passage configured to communicate with the first return hole part, and a second return hole part configured to communicate with the return passage and through which the ball member is configured to enter and exit.

12. The braking apparatus of claim 11, wherein:
the ball member that enters the first return hole part is configured to be guided into the second return hole part through the return passage, and
the ball member that enters the second return hole part is configured to be guided into the first return hole part through the return passage.

13. The braking apparatus of claim 12, wherein the first return hole part is disposed to be closer to the piston than to the second return hole part.

14. The braking apparatus of claim 11, wherein the bearing comprises:
an outer ring configured to come into contact with an inner surface of the cylinder;
an inner ring configured to be rotatable within the outer ring and to come into contact with the nut screw; and
a bearing ball disposed between the outer ring and the inner ring.

15. The braking apparatus of claim 14, wherein the location fixing part comprises a contact ring part configured to come into contact with the inner ring in response to the location fixing part is combined with the nut screw.

16. A brake apparatus for a vehicle, comprising:
a caliper body comprising a cylinder;
a piston movably disposed in the cylinder and disposed to face a brake pad;
a nut screw disposed within the piston and configured to be rotated based on a rotational force received from an actuator;
a bolt screw comprising a bolt body combined with the nut screw and configured to receive a rotational force from the nut screw and a bolt head disposed to face the piston;
a bearing disposed between the cylinder and the nut screw and configured to support the nut screw so that the nut screw is rotatable within the cylinder; and
a displacement restriction part mounted on an outer surface of the nut screw and configured to restrict a relative movement of the nut screw for the bearing.

17. The braking apparatus of claim 16, wherein the displacement restriction part has a first side mounted on the outer surface of the nut screw and a second side extended to an outside toward an inner surface of the cylinder and configured to restrict a movement of the nut screw toward the piston within a set range.

18. The braking apparatus of claim 17, wherein:
the displacement restriction part is formed in a ring shape,
an inner circumferential part of the displacement restriction part is configured to come into contact with a stepped part of the nut screw,
an outer circumferential part of the displacement restriction part is disposed in a rear of the outer ring, and
the movement of the nut screw toward the piston is configured to be blocked in response to the displacement restriction part comes into contact with the outer ring.

19. The braking apparatus of claim 16, further comprising a fixing part configured to come into contact with and support the nut screw so that a location of the displacement restriction part is fixed on the nut screw.

20. The braking apparatus of claim 19, wherein the fixing part is configured to be inserted and mounted on a fixing groove part formed along a circumference of the outer surface of the nut screw.
